(19) United States
(12) Patent Application Publication
(10) Pub. No.: US 2026/0100144 A1
(43) Pub. Date: Apr. 9, 2026

(54) INTERACTIVE EDUCATIONAL SYSTEM FOR HISTORICAL FIGURE IDENTIFICATION THROUGH ENHANCED DIALOGUE AND IMAGE GENERATION USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Sean Carlson, Savage, MN (US); Janet Demir, Ortaca (TR); Akshay Mate, Nanaimo (CA); Niraj Patel, Dubai (AE)

(73) Assignee: 2hr Learning, Inc., Austin, TX (US)

(21) Appl. No.: 19/352,309

(22) Filed: Oct. 7, 2025

Related U.S. Application Data
(60) Provisional application No. 63/704,440, filed on Oct. 7, 2024.

(51) Int. Cl. G09B 19/00; G06T 13/40; G09B 5/06; G09B 7/04; G10L 15/26

(52) U.S. Cl. CPC G09B 19/0046; G06T 13/40; G09B 5/06; G09B 7/04; G10L 15/26

(57) ABSTRACT

A virtual character identification system for guiding an AI engine to identify a virtual character based on AI-generated dialogues and images on an online learning platform is disclosed. The virtual character identification method involves collecting input data from user profiles and data models. The collected data is analyzed to generate insights that are used for prompt creation. These prompts are then used to guide the AI engine to generate text dialogues, which include an introduction, hints, and learning content. The AI engine also converts these dialogues into speech and dynamically generates images of the virtual character, where the image is progressively revealed based on user interaction. Furthermore, interactive audio-visual feedback, including educational videos with the virtual character, is provided to enhance the learning experience, allowing real-time engagement between the user and the platform.

### CROSS-REFERENCE TO RELATED APPLICATION(S)

This application claims the benefit under 35 U.S.C. § 119 (c) and 37 C.F.R. § 1.78 of U.S. Provisional Application No. 63/704,440, which is incorporated by reference in its entirety.

### FIELD OF THE INVENTION

The present invention relates in general to the field of electronics, and more specifically to a guided and constrained Artificial Intelligence (AI)-driven system involving the identification of a virtual character by a user using an online learning platform. The AI-driven system generates dialogues for the virtual character and processes the generated images based on the user interaction with the online learning platform.

### BACKGROUND OF THE INVENTION

Traditional educational tools and teaching methods have long struggled to effectively engage students and promote user interaction with online learning platforms. Many of these approaches rely heavily on static content, such as textbooks, worksheets, and pre-recorded video lessons, which offer little to no interactivity or real-time engagement. This type of content is often presented in a one-size-fits-all manner, without considering individual students' diverse learning styles, paces, or preferences. As a result, students may quickly lose interest or feel disconnected from the learning content, leading to lower levels of attention and poor retention of important concepts.

Conventionally, even when educational software attempted to introduce interactive elements, such as quizzes or multiple-choice tests, these features were often detached from the core learning content. For example, students might watch a video or read a chapter and then complete a quiz afterward, but the quiz itself wouldn't dynamically adapt to their responses or make them learn the concepts in a meaningful way. This experience reduces the effectiveness of these tools, as they do not provide feedback or adjust the difficulty based on the learner's progress or comprehension.

Furthermore, conventional educational methods often fail to engage students in active learning, which is crucial for providing critical thinking and deep understanding. In subjects like history, for instance, traditional approaches might involve reading through dense texts or passively watching videos, and none of these approaches encourage active problem-solving or inquiry-based learning. These methods fail to engage the students and do not encourage students to think critically, analyze historical events, or relate what they've learned to contemporary issues. The absence of interactive, adaptable, and immersive learning experiences in traditional education often leaves students disengaged, struggling to retain the material, and unable to form meaningful connections to the content, which hinders the educational development of the students.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary virtual character identification system based on generated dialogue and images, by the user using an online learning platform.

FIG. 2 depicts an exemplary virtual character identification process based on generated dialogue and images, by the user using an online learning platform.

FIG. 3 depicts an exemplary virtual character identification game generation process, which is an embodiment of the virtual character identification process based on generated dialogue and images, by the user using an online learning platform of FIG. 2.

FIG. 4 depicts an exemplary user interaction process with the online learning platform, which is an embodiment of the virtual character identification process based on generated dialogue and images, by the user using an online learning platform of FIG. 2.

FIG. 5 depicts an exemplary user interface presenting a virtual character identification game to the user.

FIG. 6 depicts an exemplary user interface that discloses the details of the user's educational standard and the subject matter they are currently studying.

FIG. 7 depicts an exemplary user interface presenting a virtual character identification game to the user along with a blurred image of the virtual character, three hints, and ten guessing set figure's names.

FIG. 8 depicts an exemplary user interface displaying the incorrect response provided by the user which is denoted with red color.

FIG. 9 depicts an exemplary user interface displaying that the user is provided with another hint when the user provides an incorrect response.

FIG. 10 depicts an exemplary user interface displaying the revealed image of the virtual character, and an educational video when the user submits the correct response.

FIG. 11 depicts a data structure for organizing data to create an educational video featuring the virtual character presenting the learning content.

FIG. 12 depicts an exemplary network environment in which the virtual character identification system based on generated dialogue and images, by the user using an online learning platform of FIG. 1 and the virtual character identification process based on generated dialogue and images, by the user using an online learning platform of FIG. 2 may be practiced.

FIG. 13 depicts an exemplary computer system.

### DETAILED DESCRIPTION

A virtual character identification system and process to guide an AI (Artificial Intelligence) engine to identify a virtual character based on generated dialogue and images of the virtual character, by a user using an online learning platform is disclosed. The online learning platform is operatively coupled to an input data processing module. A data collector integrated within the input data processing module fetches input data from a user profile, stored in the memory of the online learning platform. The fetched input data is analyzed using an analyzer to generate the insights that are useful in generating prompts. A prompt generator utilizes a prompt structure, provided to the prompt generator by a prompt engineer. The prompt structure is populated based on the insights provided by the analyzer. The prompt structure includes the basic skeleton of the prompt, rules, and guidelines to generate the prompt.

The generated prompts are then transferred to the AI engine which utilizes these prompts to generate dialogues and images of the virtual character. The dialogues are generated by a dialogue generator, integrated within the AI engine. The generated dialogues include an introductory message providing brief details about the virtual character, three hints that guide the user to identify the virtual character, and learning content. The generated dialogues are in text format which are further converted into speech by using a text-to-speech converter.

An image generator generates the photorealistic images of the virtual character which are blurred initially and revealed based on the response provided by the user on the online learning platform. If the user provides a correct response, the image is revealed to the user. However, if the user makes an incorrect response, the user is provided with additional hints in audio-visual format. Finally, after the identification of the virtual character, an educational video is presented to the user featuring the virtual character, who presents learning content to the user in the audio-video format.

This virtual character identification system offers an interactive online learning platform by combining AI-driven dialogue generation with dynamic image processing and personalized audio-visual feedback. The virtual character identification system enhances user engagement by using real-time image manipulation, where images are progressively revealed based on user responses, and dynamically generated dialogues are generated in correspondence with the educational standard of the user. With lifelike voice synthesis and interactive feedback, the virtual character identification system provides instant hints and enhances learning by providing both auditory and visual cues.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not even recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

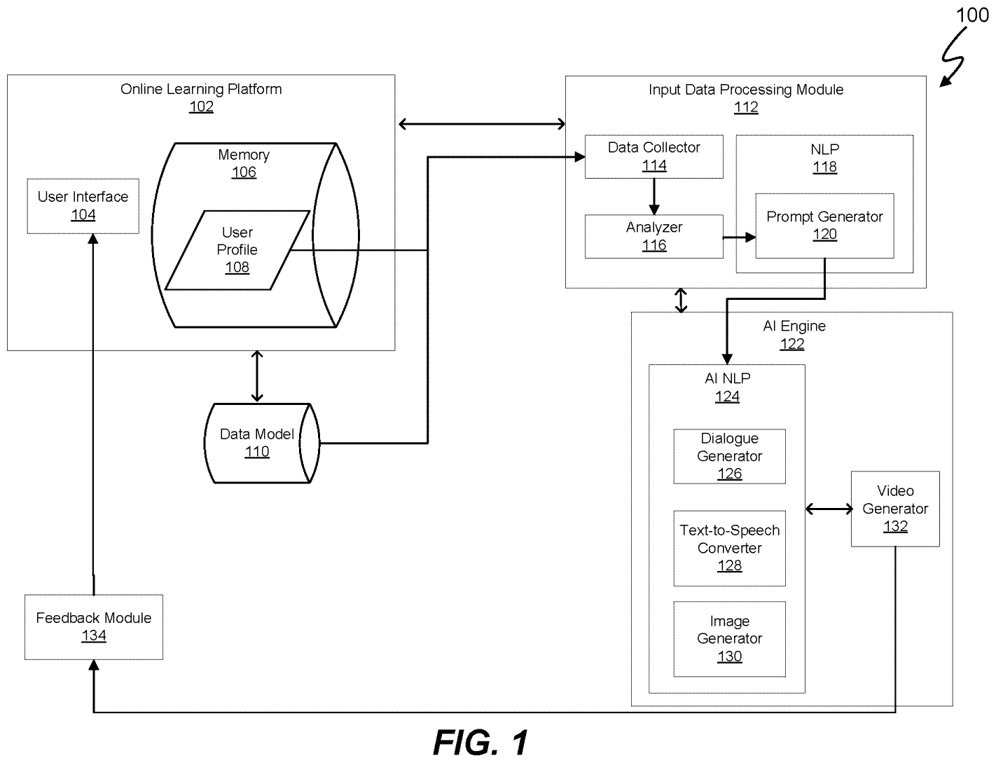

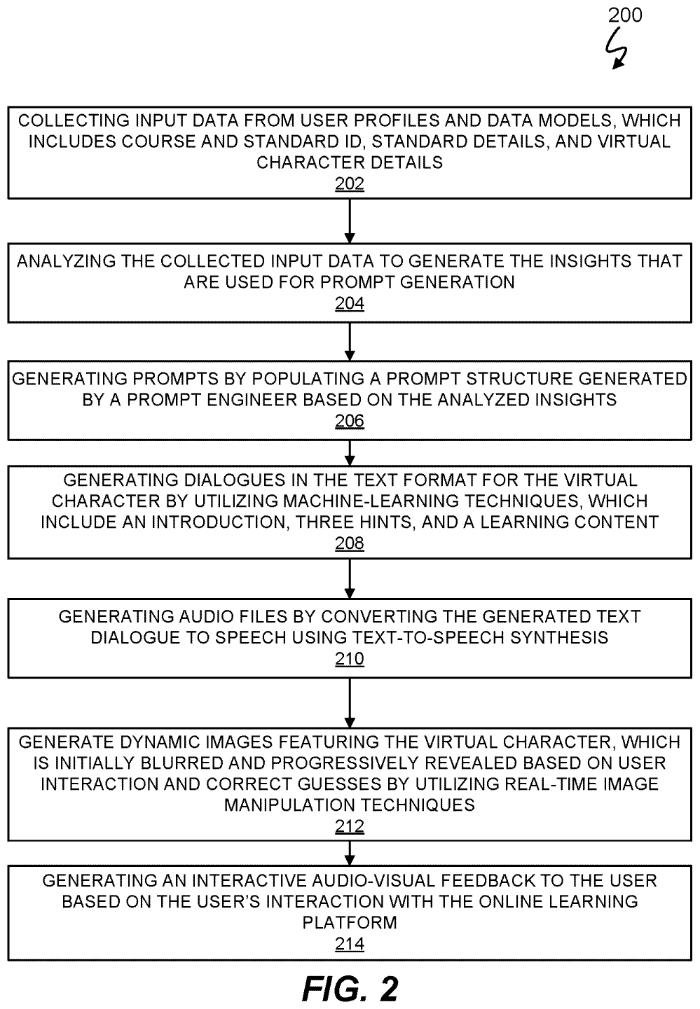

FIG. 1 depicts an exemplary virtual character identification system 100 based on generated dialogue and images, by the user using an online learning platform 102. FIG. 2 depicts an exemplary virtual character identification process 200 based on generated dialogue and images, by the user using an online learning platform 102.

Referring to FIGS. 1 and 2 in operation 202, a data collector 114 collects input data from user profile 108 and data model 110. The details of the user profile 108 are stored in memory 106, which is integrated into the online learning platform 102. The input data includes course and standard ID, standard details, and virtual character details.

The data collector 114 is integrated within an input data processing module 112, which is operatively coupled to the online learning platform 102. The data collector fetches the input data from the user profile 108 and the data model 110. The user profile 108 includes all the details about the user, including educational standards, course ID and details, user interaction with the online learning platform 102, user preferences, and so on. The user profile 108 is stored in the memory of the online learning platform 102. The data model 110 includes details of the virtual character, including virtual character ID, voice ID of the virtual character, and historical metadata of the virtual character.

The virtual character presented via the online learning platform 102 is a historical figure avatar, generated by the AI engine 122 (discussed in detail in operation 212), which acts as a real-time tutor for the user. This virtual character provides personalized, interactive guidance, enhancing the learning experience by presenting educational content and engaging the user through dialogue, visuals, and audio.

To initiate the virtual character identification process 200, the input data such as the course, standard ID, and standard details are collected from the user's profile 108. This information helps in the selection of the virtual character. Based on the educational standard and course details of the user, the virtual character is chosen, such that the virtual character is in correspondence with the educational standard of the user. For instance, the user of Grade 6 has an interest in US History and may be presented with an image of ‘Abraham Lincoln’, or any other known leader in US History, who is a part of the educational curriculum of the user.

Additionally, the virtual character details are obtained from the data model 110. These details include key identifiers of the historical figure who will act as the user's virtual tutor, such as the character's name, a photorealistic image, and a corresponding voice ID, making the user interaction with the online learning platform 102 feel more lifelike.

Further enriching the interaction, the virtual character details include a guessing set figure's name. This set consists of a list of ten historical figures' names, one of whom is the actual virtual character acting as the tutor. The user's task is to guess which figure is the actual virtual character shown in the blurred image, progressively revealed through clues such as dialogue, hints, and learning content. This guessing set adds a gamified element to the learning experience and enhances user engagement and interaction with the online learning platform 102.

In operation 204, an analyzer 116 analyzes the data collected from the data collector 114 and generates useful insights in prompt generation.

The analyzer 116 is integrated within the input data processing module 112 and is configured to receive the collected input data from the data collector 114. The analyzer 116 analyzes the collected input data and generates insights from the input data which is useful in prompt generation. These insights serve as the foundation for generating content that aligns with the user's learning requirements and the specific course standards. The insights might include key details such as learning objectives, user preferences, and virtual character details, all of which are crucial for creating a personalized and engaging learning experience.

The generated insights are used by a prompt generator 120 to generate the prompts to guide the AI engine 122. The prompt generator 120 utilizes the analyzed insights to populate a prompt structure provided by a prompt engineer.

An exemplary dataset of the analyzed insights which are used by the prompt generator to populate the prompt structure is given below:

| Course | Standard | Figure Name | |
|---|---|---|---|
| $course | ID | mainFigureName | Guessing Set |
| 5th Grade: US | 5.6.3 | Abigail Adams | [“Abigail Adams”, “Martha Washington”, “Deborah Sampson”, “Sybil |
| History (1491- | | | Ludington”, “Esther de Berdt Reed”, “Nancy Hart”, “Catherine |
| 1850) | | | Littlefield Greene”, “Elizabeth Freeman”, “Anne Bailey”, “Elizabeth |
| | | | Burgin”] |
| 5th Grade: US | 5.6.2 | Benjamin Franklin | [“Benjamin Franklin”, “John Adams”, “Thomas Jefferson”, “James |
| History (1491- | | | Madison”, “Alexander Hamilton”, “Thomas Paine”, “John Jay”, “Samuel |
| 1850) | | | Adams”, “Richard Henry Lee”, “Nathanael Greene”] |
| 5th Grade: US | 5.3.4 | Chief John Ross | [“Chief John Ross”, “Chief Sequoyah”, “Chief Sitting Bull”, “Chief |
| History (1491- | | | Black Hawk”, “Tecumseh”, “Chief Red Cloud”, “Chief Joseph”, “Chief |
| 1850) | | | Powhatan”, “Chief Osceola”, “Chief Little Turtle”] |
| 6th Grade: Ancient | 6.3.3 | Abraham | [“Abraham”, “Moses”, “David”, “Solomon”, “Jacob”, “Isaac”, “Joseph”, |
| World History | | | “Aaron”, “Samuel”, “Elijah”] |
| 6th Grade: Ancient | 6.4.7 | Alexander the Great | [“Alexander the Great”, “Philip II of Macedon”, “Darius III of |
| World History | | | Persia”, “Ptolemy I Soter”, “Seleucus I Nicator”, “Antigonus I |
| | | | Monophthalmus”, “Cassander of Macedon”, “Lysimachus of |
| | | | Thrace”, “Demosthenes”, “Pericles”] |
| 7th Grade: | 7.11.3 | Adam Smith | [“Adam Smith”, “John Locke”, “Isaac Newton”, “Voltaire”, “Francis |
| Medieval & Early | | | Bacon”, “Thomas Hobbes”, “David Hume”, “Rene Descartes”, “Baruch |
| Modern World | | | Spinoza”, “Denis Diderot”] |
| History | | | |
| 7th Grade: | 7.6.4 | Charlemagne | [“Charlemagne”, “Henry V”, “Philip II”, “Edward III”, “Henry |
| Medieval & Early | | | II”, “Richard the Lionheart”, “William the Conqueror”, “King |
| Modern World | | | John”, “Henry VIII”, “Elizabeth I”] |
| History | | | |
| 7th Grade: | 7.11.2 | Christopher Columbus | [“Christopher Columbus”, “James Cook”, “Ferdinand |
| Medieval & Early | | | Magellan”, “Francis Drake”, “Hernan Cortes”, “Marco Polo”, “Samuel |
| Modern World | | | de Champlain”, “John Cabot”, “Amerigo Vespucci”, “Jacques Cartier”] |
| History | | | |
| 8th Grade: US | 8.10.5 | Abraham Lincoln | [“Abraham Lincoln”, “Ulysses S. Grant”, “Jefferson Davis”, “Robert E. |
| History (1787- | | | Lee”, “Andrew Johnson”, “Stonewall Jackson”, “William T. |
| 1898) | | | Sherman”, “John Wilkes Booth”, “Stephen A. Douglas”, “James |
| | | | Buchanan”] |
| 8th Grade: US | 8.3.4 | Alexander Hamilton | [“Alexander Hamilton”, “Thomas Jefferson”, “George |
| History (1787- | | | Washington”, “John Adams”, “James Madison”, “Aaron Burr”, “John |
| 1898) | | | Jay”, “James Monroe”, “Benjamin Franklin”, “John Hancock”] |
| AP Biology | SYI-1.D.3 + 6 | Albert Claude | [“Albert Claude”, “Christian de Duve”, “George E. Palade”, “Rosalind |
| | | | Franklin”, “James Watson”, “Francis Crick”, “Theodor |
| | | | Schwann”, “Matthias Jakob Schleiden”, “Robert Hooke”, “Rudolf |
| | | | Virchow”] |
| AP Biology | SYI-3.G.2 + 1 | Aldo Leopold | [“Aldo Leopold”, “Rachel Carson”, “Edward O. Wilson”, “John |
| | | | Muir”, “Charles Darwin”, “George Perkins Marsh”, “Gilbert |
| | | | White”, “Gifford Pinchot”, “Henry David Thoreau”, “Ernst Haeckel”] |
| AP Biology | ENE-1.F.1 + 1 | Christian Anfinsen | [“Christian Anfinsen”, “Frederick Sanger”, “Paul L. Modrich”, “Thomas |
| | | | Steitz”, “Roger D. Kornberg”, “Aziz Sancar”, “Venkatraman |
| | | | Ramakrishnan”, “Yoshinori Ohsumi”, “Frances H. Arnold”, “Paul L. |
| | | | Boyer”] |
| AP Biology | ENE-1.F.1 + 3 | Christian Anfinsen | [“Christian Anfinsen”, “Linus Pauling”, “John B. Fenn”, “Emil |
| | | | Fischer”, “Richard J. Roberts”, “Frederick Sanger”, “Robert H. |
| | | | Grubbs”, “Herbert A. Hauptman”, “Kary Mullis”, “Paul L. Modrich”] |
| AP Biology | ENE-1.F.2 | Christian Bohr | [“Christian Bohr”, “Max Perutz”, “Frederick Sanger”, “Emil |
| | | | Fischer”, “Linus Pauling”, “James Watson”, “Francis Crick”, “Rosalind |
| | | | Franklin”, “Richard J. Roberts”, “Har Gobind Khorana”] |
| AP Biology | SYI-1.D.6 + 1 | Christian de Duve | [“Christian de Duve”, “Robert Hooke”, “Matthias Jakob |
| | | | Schleiden”, “Theodor Schwann”, “Rudolf Virchow”, “Lynn |
| | | | Margulis”, “Camillo Golgi”, “G. E. Palade”, “James Watson”, “Francis |
| | | | Crick”] |
| AP Biology | IST-1.N.6 + 3 | James Watson | [“James Watson”, “Francis Crick”, “Rosalind Franklin”, “Maurice |
| | | | Wilkins”, “Frederick Sanger”, “Linus Pauling”, “Erwin |
| | | | Chargaff”, “Elizabeth Blackburn”, “Carol W. Greider”, “Craig Venter”] |
| AP Biology | ENE-1.I.1 + 1 | Jan Ingenhousz | [“Jan Ingenhousz”, “Julius Von Sachs”, “Jean Senebier”, “Theodore de |
| | | | Saussure”, “Frederick Blackman”, “Robert Emerson”, “Daniel |
| | | | Arnon”, “Melvin Calvin”, “Andrew Benson”, “James Bassham”] |
| AP Biology | ENE-2.G.4 | Jens Skou | [“Jens Christian Skou”, “Paul L. Modrich”, “Erwin Neher”, “Bert |
| | | | Sakmann”, “Robert Lefkowitz”, “Brian Kobilka”, “Rod |
| | | | Mackinnon”, “Peter Agre”, “Roderick Mackinnon”, “Eric Betzig”] |
| AP Biology | IST-4.A.2 + 4 | Jerome Lejeune | [“Jerome Lejeune”, “Stanley Cohen”, “Rosalind Franklin”, “Gregor |
| | | | Mendel”, “Francis Crick”, “James D. Watson”, “Michael |
| | | | Smith”, “Thomas Hunt Morgan”, “Alfred Hershey”, “Martha Chase”] |
| AP Biology | IST-4.B.1 + 6 | Joshua Lederberg | [“Joshua Lederberg”, “Edward Tatum”, “George Beadle”, “Max |
| | | | Delbruck”, “James Watson”, “Francis Crick”, “Rosalind |
| | | | Franklin”, “Alfred Hershey”, “Martha Chase”, “Linus Pauling”] |
| AP Biology | IST-1.P.1 + 3 | Kary Mullis | [“Kary Mullis”, “James Watson”, “Francis Crick”, “Rosalind |
| | | | Franklin”, “Frederick Sanger”, “Paul Berg”, “Thomas Brock”, “Max |
| | | | Perutz”, “Carlo Urbani”, “Linus Pauling”] |
| AP Biology | SYI-1.D.3 + 1 | Keith Porter | [“Keith R. Porter”, “Robert Hooke”, “Matthias Schleiden”, “Theodor |
| | | | Schwann”, “Rudolf Virchow”, “James Watson”, “Francis |
| | | | Crick”, “Rosalind Franklin”, “Carl Linnaeus”, “Louis Pasteur”] |
| AP Biology | IST-5.A.2 + 1 | Konrad Lorenz | [“Konrad Lorenz”, “Nikolaas Tinbergen”, “Karl von Frisch”, “Robert |
| | | | Hinde”, “B. F. Skinner”, “John B. Watson”, “Ivan Pavlov”, “Edward |
| | | | Thorndike”, “Erich Fromm”, “Sigmund Freud”] |
| AP Biology | ENE-1.E.1 + 2 | Leonor Michaelis | [“Leonor Michaelis”, “Maud Menten”, “Linus Pauling”, “Henry |
| | | | Eyring”, “Irwin Rose”, “Avram Hershko”, “Alexander |
| | | | Varshavsky”, “Albert Claude”, “Christian de Duve”, “James Rothman”] |
| AP Biology | ENE-1.O.2 + 1 | Raymond Lindeman | [“Raymond Lindeman”, “Charles Elton”, “G. Evelyn |
| | | | Hutchinson”, “Rachel Carson”, “Jane Goodall”, “Charles |
| | | | Darwin”, “Aldo Leopold”, “Eugene Odum”, “Carl Linnaeus”, “Henry |
| | | | Chandler Cowles”] |
| AP Biology | SYI-1.A.1 | Linus Pauling | [“Linus Pauling”, “John B. Goodenough”, “Stanley Miller”, “Harold |
| | | | Urey”, “Alain Aspect”, “George Smith”, “Caroline Dean”, “John |
| | | | Gurdon”, “Yoshinori Ohsumi”, “Stanley Cohen”] |
| AP Biology | ENE-1.K.1 | Louis Pasteur | [“Louis Pasteur”, “Robert Koch”, “Emil Du Bois-Reymond”, “Carl |
| | | | Linnaeus”, “Wilhelm Wundt”, “Francis Crick”, “Gregor |
| | | | Mendel”, “Rosalind Franklin”, “Antonie van Leeuwenhoek”, “Ernst |
| | | | Mayr”] |
| AP Biology | SYI-1.D.8 + 3 | Lynn Margulis | [“Lynn Margulis”, “Carl Woese”, “Robert Koch”, “Charles |
| | | | Darwin”, “George E. Palade”, “Theodor Schwann”, “Louis |
| | | | Pasteur”, “Antonie van Leeuwenhoek”, “Rudolf Virchow”, “Ernst |
| | | | Haeckel”] |
| AP Biology | IST-1.O.1 | Marshall Nirenberg | [“Marshall Nirenberg”, “Francis Crick”, “James Watson”, “Frederick |
| | | | Sanger”, “Selman Waksman”, “Andrew Fire”, “Craig Mello”, “Elizabeth |
| | | | Blackburn”, “Carol W. Greider”, “Har Gobind Khorana”] |
| AP Biology | IST-2.C.1 + 2 | Max Delbruck | [“Max Delbruck”, “James Watson”, “Francis Crick”, “Rosalind |
| | | | Franklin”, “Maurice Wilkins”, “Gregor Mendel”, “Barbara |
| | | | McClintock”, “Thomas Hunt Morgan”, “Linus Pauling”, “Alfred |
| | | | Hershey”] |
| AP Biology | ENE-1.I.2 | Melvin Calvin | [“Melvin Calvin”, “Robert Hill”, “Emil Fischer”, “Hans |
| | | | Krebs”, “Frederick Blackman”, “A. A. Benson”, “Andrew |
| | | | Benson”, “Daniel Arnon”, “Martin Kamen”, “Sam Ruben”] |
| AP Biology | IST-3.G.1 + 2 | Michael N. Hall | [“Michael N. Hall”, “Albert Claude”, “Keith Roberts Porter”, “George |
| | | | Emil Palade”, “Alfred G. Gilman”, “Martin Rodbell”, “Gunther |
| | | | Blobel”, “Elisabeth Blackburn”, “Carol W. Greider”, “Yoshinori |
| | | | Ohsumi”] |
| AP Biology | IST-5.A.1 | Niko Tinbergen | [“Nikolaas Tinbergen”, “Konrad Lorenz”, “Edward O. Wilson”, “Jane |
| | | | Goodall”, “E. O. Pianka”, “Rachel Carson”, “Eugene P. Odum”, “Dian |
| | | | Fossey”, “Henry David Thoreau”, “Louis Agassiz”] |
| AP Biology | ENE-1.E.1 + 1 | Otto Fritz Meyerhof | [“Otto Fritz Meyerhof”, “Hans Krebs”, “Albert Szent-Györgyi”, “Carl |
| | | | Ferdinand Cori”, “Gerty Cori”, “Earl W. Sutherland Jr.”, “Luis F. |
| | | | Leloir”, “Erwin Chargaff”, “Konrad Bloch”, “Paul L. Modrich”] |
| AP Biology | ENE-1.K.3 + 6 | Otto Heinrich Warburg | [“Otto Heinrich Warburg”, “Hans Adolf Krebs”, “Albert Szent- |
| | | | Györgyi”, “Selman Waksman”, “Fritz Albert Lipmann”, “Severo |
| | | | Ochoa”, “Albert Claude”, “Christian de Duve”, “Edwin G. Krebs”, “Carl |
| | | | Ferdinand Cori”] |
| AP Biology | IST-3.C.2 | Paul L. Modrich | [“Paul L. Modrich”, “Aziz Sancar”, “Roger D. Kornberg”, “Elizabeth |
| | | | Blackburn”, “Walter Gilbert”, “Richard J. Roberts”, “James E. |
| | | | Rothman”, “Thomas C. Sudhof”, “Kary Mullis”, “Randy W. |
| | | | Schekman”] |
| AP United States | KC-8.1.II.B | Abbie Hoffman | [“Abbie Hoffman”, “Jerry Rubin”, “Timothy Leary”, “Alan |
| History | | | Ginsberg”, “Mario Savio”, “Grace Slick”, “Tom Hayden”, “John |
| | | | Lennon”, “Angela Davis”, “Richard M. Nixon”] |
| AP United States | KC-3.2.I.D | Abigail Adams | [“Abigail Adams”, “Martha Washington”, “Deborah Sampson”, “Betsy |
| History | | | Ross”, “Mary Ludwig Hays”, “Mercy Otis Warren”, “Judith Sargent |
| | | | Murray”, “Phillis Wheatley”, “Molly Pitcher”, “Elizabeth Freeman”] |
| AP United States | KC-8.2.II.B | Cesar Chavez | [“Cesar Chavez”, “Martin Luther King Jr.”, “Harvey Milk”, “Gloria |
| History | | | Steinem”, “Rosa Parks”, “Malcolm X”, “Huey Newton”, “Betty |
| | | | Friedan”, “Angela Davis”, “Dolores Huerta”] |
| AP United States | KC-4.1.II.A.i | Charles Grandison Finney | [“Charles Grandison Finney”, “Lyman Beecher”, “William |
| History | | | Miller”, “Joseph Smith”, “Ralph Waldo Emerson”, “Henry David |
| | | | Thoreau”, “Horace Mann”, “Nathaniel Hawthorne”, “Elizabeth Cady |
| | | | Stanton”, “Frederick Douglass”] |
| AP United States | KC-7.3.II | Woodrow Wilson | [“Woodrow Wilson”, “Theodore Roosevelt”, “Franklin D. |
| History | | | Roosevelt”, “Herbert Hoover”, “Harry S. Truman”, “Dwight D. |
| | | | Eisenhower”, “William Howard Taft”, “Calvin Coolidge”, “Warren G. |
| | | | Harding”, “John J. Pershing”] |
| AP World History: | KC-4.1.II | Galileo Galilei | [“Galileo Galilei”, “Johannes Kepler”, “Isaac Newton”, “Nicolaus |
| Modern | | | Copernicus”, “Christopher Columbus”, “Vasco da Gama”, “Francis |
| | | | Bacon”, “Thomas Paine”, “Antonie van Leeuwenhoek”, “James Watt”] |
| AP World History: | KC-6.2.II | Mahatma Gandhi | [“Gandhi”, “Nelson Mandela”, “Martin Luther King Jr.”, “Winston |
| Modern | | | Churchill”, “Nehru”, “Ho Chi Minh”, “Che Guevara”, “Fidel |
| | | | Castro”, “Patrice Lumumba”, “Mao Zedong”] |
| High School | HS-ESS1-5 | Alfred Wegener | [“Alfred Wegener”, “Harry Hess”, “J. Tuzo Wilson”, “Arthur |
| Biology | | | Holmes”, “Charles Richter”, “Edward Bullard”, “Marie Tharp”, “Bruce |
| | | | Heezen”, “Felix Andries Vening Meinesz”, “Lawrence W. Morley”] |
| High School | HS-PS4-4 | Albert Einstein | [“Albert Einstein”, “Niels Bohr”, “Max Planck”, “Erwin |
| Physics | | | Schrodinger”, “Werner Heisenberg”, “Paul Dirac”, “James Clerk |
| | | | Maxwell”, “Louis de Broglie”, “Richard Feynman”, “David Bohm”] |
| High School | HS-ETS1-2 | Alexander Graham Bell | [“Alexander Graham Bell”, “Thomas Edison”, “Nikola |
| Physics | | | Tesla”, “Guglielmo Marconi”, “Eli Whitney”, “Henry Ford”, “George |
| | | | Stephenson”, “James Watt”, “Archimedes”, “Leonardo Da Vinci”] |
| High School | HS-ESS1-1 | Henrietta Swan Leavitt | [“Henrietta Swan Leavitt”, “Edward Charles Pickering”, “Annie Jump |
| Physics | | | Cannon”, “Cecilia Payne-Gaposchkin”, “Edwin Hubble”, “Karl |
| | | | Schwarzschild”, “Subrahmanyan Chandrasekhar”, “Arthur Stanley |
| | | | Eddington”, “Georges Lemaitre”, “Werner Heisenberg”] |
| High School: US | 12.9.8 | Nelson Mandela | [“Nelson Mandela”, “Fidel Castro”, “Jomo Kenyatta”, “Robert |
| Government | | | Mugabe”, “Mahatma Gandhi”, “Augusto Pinochet”, “Desmond |
| | | | Tutu”, “Anwar Sadat”, “Jawaharlal Nehru”, “Thomas Sankara”] |
| High School: US | 12.16.4 | Paul Volcker | [“Paul Volcker”, “Ben Bernanke”, “Janet Yellen”, “Alan |
| Government | | | Greenspan”, “Arthur Burns”, “Milton Friedman”, “John Maynard |
| | | | Keynes”, “J. Bradford DeLong”, “Henry Paulson”, “Timothy Geithner”] |
| High School: US | 12.4.4 | George Washington | [“George Washington”, “Thomas Jefferson”, “Abraham |
| Government | | | Lincoln”, “Franklin D. Roosevelt”, “John F. Kennedy”, “Ronald |
| | | | Reagan”, “Woodrow Wilson”, “Theodore Roosevelt”, “James |
| | | | Madison”, “Andrew Jackson”] |
| High School: | 10.8.3 | Winston Churchill | [“Winston Churchill”, “Franklin D. Roosevelt”, “Adolf Hitler”, “Joseph |
| World History | | | Stalin”, “Benito Mussolini”, “Hirohito”, “Dwight D. |
| | | | Eisenhower”, “Harry S. Truman”, “Charles de Gaulle”, “Heinrich |
| | | | Himmler”] |
| High School: | 10.6.1 | Woodrow Wilson | [“Woodrow Wilson”, “Lloyd George”, “Georges |
| World History | | | Clemenceau”, “Vittorio Orlando”, “Kaiser Wilhelm II”, “Vladimir |
| | | | Lenin”, “Herbert Hoover”, “Franklin D. Roosevelt”, “Joseph |
| | | | Joffre”, “Paul von Hindenburg”] |
| Middle School | MS-LS1-4 | Charles Darwin | [“Charles Darwin”, “Carolus Linnaeus”, “George Lois”, “Gregor |
| Biology | | | Mendel”, “Jean-Baptiste Lamarck”, “Alfred Russel Wallace”, “Roslin |
| | | | Franklin”, “Herbert Spencer”, “Ernst Mayr”, “Theodosius Dobzhansky”] |
| Middle School | MS-LS2-3 | Rachel Carson | [“Rachel Carson”, “Jane Goodall”, “David Attenborough”, “E. O. |
| Biology | | | Wilson”, “Gregor Mendel”, “James Lovelock”, “Henry David |
| | | | Thoreau”, “Charles Darwin”, “Alexander von Humboldt”, “Aldo |
| | | | Leopold”] |
| Middle School | MS-LS1-2 | Robert Hooke | [“Robert Hooke”, “Rudolf Virchow”, “Matthias Schleiden”, “Theodor |
| Biology | | | Schwann”, “Louis Pasteur”, “Jan van Helmont”, “Carl |
| | | | Linnaeus”, “Melvin Calvin”, “Ernst Haeckel”, “Gregor Mendel”] |
| Middle School | MS-ESS2-3 | Alfred Wegener | [“Alfred Wegener”, “Charles Darwin”, “Marie Tharp”, “James |
| Earth and Space | | | Hutton”, “Nicolaus Steno”, “Henry Morris”, “Mary Anning”, “Bruce C. |
| Science | | | Heezen”, “Sir Charles Lyell”, “Louis Agassiz”] |
| Middle School | MS-ESS1-3 | Galileo Galilei | [“Galileo Galilei”, “Nicolaus Copernicus”, “Johannes Kepler”, “Isaac |
| Earth and Space | | | Newton”, “Edwin Hubble”, “Christiaan Huygens”, “Ptolemy”, “Carl |
| Science | | | Sagan”, “Tycho Brahe”, “William Herschel”] |
| Middle School | MS-ETS1-2 | Henry Ford | [“Henry Ford”, “Alexander Graham Bell”, “Thomas Edison”, “Nikola |
| Physics | | | Tesla”, “George Westinghouse”, “John D. Rockefeller”, “Alfred P. |
| | | | Sloan”, “Sir Richard Branson”, “James Watt”, “Samuel Colt”] |
| Middle School | MS-ETS1-4 | Thomas Edison | [“Thomas Edison”, “Nikola Tesla”, “Alexander Graham Bell”, “James |
| Physics | | | Watt”, “Guglielmo Marconi”, “Eli Whitney”, “Leonardo da |
| | | | Vinci”, “Isambard Kingdom Brunel”, “Archimedes”, “Karl Benz”] |

In operation 206, the prompt generator 120 generates prompts by populating a prompt structure provided by a prompt engineer based on the analyzed insights.

Before generating the prompts by the prompt generator 120, the prompt structure is provided to the prompt generator 120. The prompt structure is generated by the prompt engineer. The prompt structure includes a structure or skeleton of the prompt, along with the context, rules, examples, and guidelines for guiding the prompt generator 120 to generate the prompts.

An exemplary prompt structure provided by the prompt engineer for the dialogue generation is given below. Through the execution of code, the prompt generator 120 programmatically accesses a prompt template and populates input data into the prompt. For example:

″ratings″: {
″introduction_quality″: “[input data]″,
″hint_1_helpfulness″: ″[input data]″,
″hint_2_helpfulness″: ″[input data]″,
″hint_3_helpfulness″: ″[input data]″,
″learning_content_quality″: ″[input data]″
}
PROMPT:
Context
--------
You are a guessing game dialogue generator whose task is to write
entertaining, relatable, and educative dialogues from the perspective of a
Historical Figure. The well-spoken yet snarky dialogues will serve as clues,
and the students will have to guess the speaker's identity based on the
information provided. Clues are written in plain English which a gen-Z
student will understand. Use the example below as a reference for a high-
quality output:
Examples:
--------
{
″introduction″: ″You're in the presence of a notorious American leader! I've
walked the halls of the white house, shaken hands with kings and queens, and
left my footprints in the sands of the Middle East. Do you have the
historical chops to guess who I am? Listen carefully, ′cause I'm not going to
make this easy.″,
″hint_1″: ″Perhaps you'll remember me by my musical side. Amidst my political
achievements, I once took a moment to serenade the nation with a masterful
piano performance during a live television broadcast.″,
″hint_2″: ″What's this? My clues have fallen on deaf ears it seems. Think
back to when global conflict touched oil wellsprings in the Middle East, and
I countered with a bold vision called Project Independence, aiming to free us
from the influence of foreign energy.″,
″hint_3″: ″Good heavens! You still need guidance? This is beginning to hurt
my feelings. Now listen closely because this is your last chance. My
presidential chapter concluded prematurely, not by the usual passing of the
torch, but amidst a scandal whose name has become inseparable from my own.″,
″learning_content″: ″Alright, I suppose I can drop the act. I am Richard
Nixon, the 37th President of the United States, in office from 1969 until
1974. I opened doors to China, eased Cold War tensions, and spearheaded
efforts towards U.S. energy self-sufficiency. But despite my political
triumphs, it's the Watergate scandal of 1972 for which I'm best remembered, a
sobering legacy and a grave lesson in the importance of integrity for all
leaders.″,
″ratings″: {
″introduction_quality″: “8″,
″hint_1_helpfulness″: ″3″,
″hint_2_helpfulness″: ″6″,
″hint_3_helpfulness″: ″8″,
″learning_content_quality″: ″9″
}
}
Output Template
--------
Introduction: A short description of the Historical Figure. The figure
introduces themselves in a well-spoken yet snarky tone, with impeccable
grammar, using language a modern gen-z student will understand. The figure
should introduce themselves in vague terms, WITHOUT revealing any identifying
information. The introduction must conclude with a challenge addressed to the
user to guess the figure's identity. The introduction should never include
idioms or turns-of-phrase.
Hint 1: A difficult and niche clue, revealing a detailed and little-known
fact about the Historical Figure, using plain-English. This clue should NOT
make any mention of the key achievements or distinguishing characteristics
for which the figure is best known. It should instead rely upon secondary
lesser-known information.
Hint 2: A moderately difficult clue, delivered by the Historical Figure, that
uses plain-English to identify an important fact about the Historical Figure.
This clue should still make no reference to the most important
accomplishment, position, or event for which the Historical Figure is known.
In the first sentence of Hint 2, the Historical Figure should express
moderate offense and give attitude to the student for needing a hint. This
hint should be only slightly more revealing than Hint 1.
Hint 3: Hint 3 should use plain-English to explicitly name the most important
individually distinguishing position, achievement, or event associated with
the Historical Figure. This clue should be as revealing as possible, and make
the identity of the speaker blatantly obvious, even to a small child, WITHOUT
directly stating the Historical Figure's name. The figure must mention that
this is the final hint, and, therefore, the student's last chance to guess
the speaker's identity. In the first sentence of Hint 3, the Historical
Figure should express utter disbelief and extreme offense that the student
needed a hint.
Learning Content: A brief lecture that mentions the Historical Figure's
identity, and explains the most important information about the Figure that
the student would need to know for the specified Course. It should connect
the hints in some fashion without trivially rehashing the hints.
Ratings: Rate the output in line with the following criteria (1-10 for each):
* Introduction Quality: How entertaining, funny, interesting, and engaging is
the introduction?
* Hint 1 Helpfulness: On a scale of 1-10, how helpful is this hint?
* Hint 2 Helpfulness: On a scale of 1-10, how helpful is this hint?
* Hint 3 Helpfulness: On a scale of 1-10, how helpful is this hint?
* Learning Content Quality: How well does the Learning Content cover the
figure's core aspects & relevance to the Course?
Rules
--------
Language rules:
* All language should sound modern and highly educated, resembling the
language style of a late-night political satirist.
* NEVER use language that is folksy, quaint, or relies upon idioms or turns
of phrase.
* Abbreviations should never be used for any terminology.
* All output elements must be dialogue delivered from the Historical Figure.
* Do NOT reference the field names or the values of ANY of the Core Inputs in
any outputs.
Rules for length and word limits :
* The Introduction should be 80 words or less.
* Each Hint should be 60 words or less.
* The Learning Content should be 100 words or less.
Hint rules:
* Do NOT mention the name of the Historical Figure.
Learning Content rules:
* The Learning Content must NEVER mention whether the student guessed
correctly or incorrectly.
* The Learning Content should never reference the name of the Course or use
the word Course.
* The Learning Content should never reference whether the user guessed the
historical figure.
* The learning Content should give a quick summary of the Figure's most
critical historical accomplishments.
* The Learning Content should emphasize and expand on the importance of the
Historical Figure and their relevance to the Course.
* The Learning Content should NEVER assume any background knowledge from the
student and must provide all relevant context to understand the historical
importance of the Main Figure.
* The Learning Content should always begin with the character unveiling their
identity.
* Do NOT include narrative descriptions of the character.
Introduction rules:
* The introduction should be so vague that the user should never be able to
guess the identity of the speaker from the introduction alone.
* The introduction should end with a question asking the student to guess the
figure's identity.
* The introduction should never address the audience directly.
* The introduction should never contain specific, identifiable
characteristics of the figure.
Output Format
--------
Format your response in valid JSON format with the following fields:
{
″introduction″: ″″,
″hint_1″: ″″,
″hint_2″:″″,
″hint_3″:″″,
″learning_content″:″″,
″ratings″: {
″introduction_quality″: ″int″,
″hint_1_helpfulness″: ″int″,
″hint_2_helpfulness″: ″int″,
″hint_3_helpfulness″: ″int″,
″learning_content_quality″: ″int″
}
}
Core Inputs
--------
Course: {{ course }}
Educational Standard: {{ standardDescription }}
Historical Figure: {{ standardAttribute ‘WhatsMyName’ }}
Guessing Set:
{{ standardAttribute ‘WhatsMyName’ ‘properties.guessingSet’ }}

Similarly, the prompt structure provided by the prompt engineer to the prompt generator 120 to generate the photorealistic image is given below:

photorealistic CGI of {{ figureName }}; head and shoulders; facing the
camera --ar 9:16

The prompt generator 120 utilizes NLP (Natural Language Processor) 118 which utilizes Natural Language Processing techniques to generate the prompts to guide the AI engine 122 to generate text dialogues, photorealistic images of the virtual character, and audio files for the virtual character. The prompt generator 120 is operatively coupled to the AI engine 122, which helps in direct transferring of the generated prompts to the AI engine 122. The prompt generator utilizes the analyzed insights from the analyzer 116 and uses them to populate the prompt structure provided by the prompt engineer.

In operation 208, the prompt generator 120 transfers the generated prompts to the AI engine 122 to guide the AI engine 122 to generate dialogues in the text format for the virtual character using a dialogue generator 126 that utilizes machine-learning techniques.

The dialogue generator 126 generates the dialogues of the virtual character by utilizing artificial intelligence (AI) and natural language processing (NLP) to generate the dialogues in text format that is in correspondence with the educational standard of the user. For this purpose, the dialogue generator 126 utilizes a natural language processor. The dialogue generator 126 is integrated within the AI engine 122 and is operatively coupled to the prompt generator 120. The dialogue generator 126 receives the prompts along with the rules and guidelines by the prompt generator 120 to generate the dialogues for the virtual character. These prompts guide the dialogue generator 126 to generate the dialogues systematically, including an introduction message to set the context, three hints designed to assist the user in understanding or identifying the virtual character, and the learning content relevant to the user's educational needs.

The introduction, hints, and learning content are all generated in correspondence with the virtual character and educational standard of the user. This means that each piece of dialogue corresponds not only to the user's needs and progress but is also related to the behavior of the virtual character being used.

The prompts provided by the prompt generator 120 to the dialogue generator 126 to generate the text dialogues for the virtual character are given below:

Context
--------
You are a guessing game dialogue generator whose task is to write
entertaining, relatable, and educative dialogues from the perspective of a
Historical Figure. The well-spoken yet snarky dialogues will serve as clues,
and the students will have to guess the speaker's identity based on the
information provided. Clues are written in plain English which a gen-Z
student will understand. Use the example below as a reference for a high-
quality output:
Examples:
--------
{
″introduction″: ″You're in the presence of a notorious American leader! I've
walked the halls of the white house, shaken hands with kings and queens, and
left my footprints in the sands of the Middle East. Do you have the
historical chops to guess who I am? Listen carefully, 'cause I'm not going to
make this easy.″,
″hint_1″: ″Perhaps you'll remember me by my musical side. Amidst my political
achievements, I once took a moment to serenade the nation with a masterful
piano performance during a live television broadcast.″,
″hint_2″: ″What's this? My clues have fallen on deaf ears it seems. Think
back to when global conflict touched oil wellsprings in the Middle East, and
I countered with a bold vision called Project Independence, aiming to free us
from the influence of foreign energy.″,
″hint_3″: ″Good heavens! You still need guidance? This is beginning to hurt
my feelings. Now listen closely because this is your last chance. My
presidential chapter concluded prematurely, not by the usual passing of the
torch, but amidst a scandal whose name has become inseparable from my own.″,
″learning_content″: ″Alright, I suppose I can drop the act. I am Richard
Nixon, the 37th President of the United States, in office from 1969 until
1974. I opened doors to China, eased Cold War tensions, and spearheaded
efforts towards U.S. energy self-sufficiency. But despite my political
triumphs, it's the Watergate scandal of 1972 for which I'm best remembered, a
sobering legacy and a grave lesson in the importance of integrity for all
leaders.″,
″ratings″: {
″introduction_quality″: “8″,
″hint_1_helpfulness″: ″3″,
″hint_2_helpfulness″: ″6″,
″hint_3_helpfulness″: ″8″,
″learning_content_quality″: ″9″
}
}
Output Template
--------
Introduction: A short description of the Historical Figure. The figure
introduces themselves in a well-spoken yet snarky tone, with impeccable
grammar, using language a modern gen-z student will understand. The figure
should introduce themselves in vague terms, WITHOUT revealing any identifying
information. The introduction must conclude with a challenge addressed to the
user to guess the figure's identity. The introduction should never include
idioms or turns-of-phrase.
Hint 1: A difficult and niche clue, revealing a detailed and little-known
fact about the Historical Figure, using plain-English. This clue should NOT
make any mention of the key achievements or distinguishing characteristics
for which the figure is best known. It should instead rely upon secondary
lesser-known information.
Hint 2: A moderately difficult clue, delivered by the Historical Figure, that
uses plain-English to identify an important fact about the Historical Figure.
This clue should still make no reference to the most important
accomplishment, position, or event for which the Historical Figure is known.
In the first sentence of Hint 2, the Historical Figure should express
moderate offense and give attitude to the student for needing a hint. This
hint should be only slightly more revealing than Hint 1.
Hint 3: Hint 3 should use plain-English to explicitly name the most important
individually distinguishing position, achievement, or event associated with
the Historical Figure. This clue should be as revealing as possible, and make
the identity of the speaker blatantly obvious, even to a small child, WITHOUT
directly stating the Historical Figure's name. The figure must mention that
this is the final hint, and, therefore, the student's last chance to guess
the speaker's identity. In the first sentence of Hint 3, the Historical
Figure should express utter disbelief and extreme offense that the student
needed a hint.
Learning Content: A brief lecture that mentions the Historical Figure's
identity, and explains the most important information about the Figure that
the student would need to know for the specified Course. It should connect
the hints in some fashion without trivially rehashing the hints.
Ratings: Rate the output in line with the following criteria (1-10 for each):
* Introduction Quality: How entertaining, funny, interesting, and engaging is
the introduction?
* Hint 1 Helpfulness: On a scale of 1-10, how helpful is this hint?
* Hint 2 Helpfulness: On a scale of 1-10, how helpful is this hint?
* Hint 3 Helpfulness: On a scale of 1-10, how helpful is this hint?
* Learning Content Quality: How well does the Learning Content cover the
figure's core aspects & relevance to the Course?
Rules
--------
Language rules:
* All language should sound modern and highly educated, resembling the
language style of a late-night political satirist.
* NEVER use language that is folksy, quaint, or relies upon idioms or turns
of phrase.
* Abbreviations should never be used for any terminology.
* All output elements must be dialogue delivered from the Historical Figure.
* Do NOT reference the field names or the values of ANY of the Core Inputs in
any outputs.
Rules for length and word limits:
* The Introduction should be 80 words or less.
* Each Hint should be 60 words or less.
* The Learning Content should be 100 words or less.
Hint rules:
* Do NOT mention the name of the Historical Figure.
Learning Content rules:
* The Learning Content must NEVER mention whether the student guessed
correctly or incorrectly.
* The Learning Content should never reference the name of the Course or use
the word Course.
* The Learning Content should never reference whether the user guessed the
historical figure.
* The learning Content should give a quick summary of the Figure's most
critical historical accomplishments.
* The Learning Content should emphasize and expand on the importance of the
Historical Figure and their relevance to the Course.
* The Learning Content should NEVER assume any background knowledge from the
student and must provide all relevant context to understand the historical
importance of the Main Figure.
* The Learning Content should always begin with the character unveiling their
identity.
* Do NOT include narrative descriptions of the character.
Introduction rules:
* The introduction should be so vague that the user should never be able to
guess the identity of the speaker from the introduction alone.
* The introduction should end with a question asking the student to guess the
figure's identity.
* The introduction should never address the audience directly.
* The introduction should never contain specific, identifiable
characteristics of the figure.
Output Format
--------
Format your response in valid JSON format with the following fields:
{
″introduction″; ″″,
″hint_1″: ″″,
″hint_2″:″″,
″hint_3″:″″,
″learning_content″; ″″,
″ratings″: {
″introduction_quality″: ″int″,
″hint_1_helpfulness″: ″int″,
″hint_2_helpfulness″: ″int″,
″hint_3_helpfulness″: ″int″,
″learning_content_quality″: ″int″
}
}
Core Inputs
--------
Course: {{ 5th Grade: US History (1491-1850) }}
Educational Standard: {{ 5.6.3 }}
Historical Figure: {{ ‘Abigail Adams’ }}
Guessing Set:
{{ standardAttribute ‘Abigail Adams’, properties. GuessingSet ‘″Abigail
Adams″,″Martha Washington″,″Deborah Sampson″,″Sybil Ludington″,″Esther de
Berdt Reed″,″Nancy Hart″,″Catherine Littlefield Greene″,″Elizabeth
Freeman″,″Anne Bailey″,″Elizabeth Burgin″’ }}

The output text dialogues generated by the dialogue generator 126 based on the prompts provided by the prompt generator 120 arc:

```
{
  “introduction”: “Oh, you're in luck! You have the opportunity to guess a
forceful name in the American Revolution, though I hardly bore arms. Instead,
my arsenal included a keen mind, a fierce will, and an extraordinary gift of
persuasion. Have I grasped your attention? Can you guess who I am?”,
  “hint_1”: “Let's not discount my panache for cultivating, harvesting - not
garden beds, mind you, but minds! My influence trickled down to the family
hearth, imparting wisdom and sparking thoughts in many a young mind.”,
  “hint_2”: “Goodness! It looks like you're still in the dust. Here's
something to consider: I was often the catalyst and a conduit for unseen
revolutions, taking shape behind the moire curtains of the domestic world.”,
  “hint_3”: “This is astounding! You still need a hint? I insist on
reminding you of my influential correspondence, particularly with a man who
held considerable sway in American politics. I urged him, among other things,
to ‘remember the ladies’.”,
  “learning content”: “Well, it's high time to introduce myself. I am
Abigail Adams, the wife of the second U.S President, John Adams. My
intellectual pursuits, wisdom, and advocacy for women's rights have made me
an essential element in establishing the ideal of ‘republican motherhood’. My
constant nudges to my husband to consider women's rights in the political
scheme have etched my name in the annals of American history.”,
  “ratings”: {
    “introduction_quality”: “8”,
    “hint_1_helpfulness”: “4”,
    “hint_2_helpfulness”: “6”,
    “hint_3_helpfulness”: “9”,
    “learning_content_quality”: “9”
}
```

In operation 210, a text-to-speech converter 128 converts the generated text dialogues into an audio file by utilizing text-to-speech synthesis. The dialogues include an introduction, three hints, and learning content.

The text-to-speech converter 128 plays a crucial role in transforming the generated text dialogues into audio files by utilizing advanced text-to-speech (TTS) synthesis technology. Text-to-speech technology, commonly known as TTS converts text into voice output. The text-to-speech conversion utilizes optical character recognition (OCR) to convert text from images or handwritten documents into machine-encoded text. This machine-encoded text can then be read aloud by the TTS tools. Prominent TTS tools incorporate web-based tools, chrome tools, text-to-speech apps, text-to-speech software, and the like.

Once the dialogue generator 126 produces the necessary text comprising the introduction, three hints, and the core learning content. The text-to-speech converter 128 uses generated text dialogues to create an audio file. The text-to-speech converter 128 converts these text-based dialogues into speech, creating audio files that are accessible and engaging for users.

The audio files are generated using voice synthesis techniques, enabling the voice in the audio to mimic the real voice, pitch, and tone of the virtual character, thereby enhancing user's learning experience. This personalized approach to voice synthesis ensures that each virtual character has a consistent, distinct voice that feels realistic and engaging. Further, using character-specific voiceovers helps deepen the user's connection to the virtual environment, providing a sense of familiarity and continuity.

In operation 212, an image generator 130 generates the dynamic photorealistic image featuring the virtual character. The image of the virtual character is initially blurred and progressively revealed based on user interaction and correct guesses by utilizing real-time image manipulation techniques.

The image generator 130 is designed to create photorealistic images of the virtual character, providing a visually appealing and engaging experience to the user. The image generator 130 utilizes real-time image manipulation techniques to dynamically control how much of the virtual character's image is to be blurred or revealed. This manipulation depends directly on the user's performance and responses during the identification of the virtual character. As the user interacts with the online learning platform 102, the image generator 130 adjusts the clarity of the virtual character's image in response to whether the user provides correct or incorrect answers. Initially, the image generated by the image generator 130 is blurred, and it keeps on revealing based on the response provided by the user.

For instance, if the user provides a correct response, the image is revealed directly. However, if the user submits an incorrect response, the AI engine 122 responds by keeping the virtual character's image blurred and triggers the next hint in a sequence, guiding the user toward the correct answer. This progressive hinting mechanism supports learning by helping the user arrive at the correct solution through additional information.

The prompt provided to the image generator 130 by the prompt generator 120 for the generation of the dynamic photorealistic image is given below:

photorealistic CGI of {{ Abigail Adams }}; head and shoulders; facing the
camera --ar 9:16

The prompt generator 120 provides the above prompt to the image generator 130 for generation of photorealistic images of ‘Abigail Adams’. The head and shoulder should be placed in such a way that the face, head, and shoulder should face the camera. The aspect ratio for the generated images should be 9:16.

In operation 214, a video generator 132 generates interactive audio-visual feedback to the user based on the user's interaction with the online learning platform 102. The generated audio-visual feedback includes an educational video featuring the virtual character presenting the learning content.

The video generator 132 is integrated within the AI engine 122 and is operatively coupled to a feedback module 134, which further provides real-time interactive audio-visual feedback to the user. The real-time audio-visual feedback is provided to the user on a user interface 104, integrated with the online learning platform 102. Also, the generated educational video is displayed to the user on the user interface 104 of the online learning platform 102.

The output presented to the user on the user interface 104 includes a blurred image of the virtual character, a list of ten guessing sets, three hints, course, and educational standard details of the user. Initially, the user is provided with the blurred image of the virtual character and an audio file that provides the basic introduction of the virtual character. The user can interact with the online learning platform 102 by guessing the response from the list of ten guessing sets. If the user makes the correct guess, the blurred image of the virtual character is revealed, and the educational video featuring the virtual character along with the educational learning video is presented to the user. However, if the user makes an incorrect guess then the user is provided with a set of three hints, for every incorrect response, the user gets access to the corresponding hint.

For instance, the generated introduction, three hints, and the learning content may be as follows:
Introduction: ‘You're in the presence of a notorious American leader! I've walked the halls of the white house, shaken hands with kings and queens, and left my footprints in the sands of the Middle East. Do you have the historical chops to guess who I am? Listen carefully, ‘cause I'm not going to make this easy.’
Hint 1: ‘Perhaps you'll remember me by my musical side. Amidst my political achievements, I once took a moment to serenade the nation with a masterful piano performance during a live television broadcast.’
Hint 2: ‘What's this? My clues have fallen on deaf ears it seems. Think back to when global conflict touched oil wellsprings in the Middle East, and I countered with a bold vision called Project Independence, aiming to free us from the influence of foreign energy.’
Hint 3: ‘Good heavens! Do you still need guidance? This is beginning to hurt my feelings. Now listen closely because this is your last chance. My presidential chapter concluded prematurely, not by the usual passing of the torch, but amidst a scandal whose name has become inseparable from my own.
Learning Content: ‘Alright, I suppose I can drop the act. I am Richard Nixon, the 37th President of the United States, in office from 1969 until 1974. I opened doors to China, eased Cold War tensions, and spearheaded efforts toward U.S. energy self-sufficiency. But despite my political triumphs, it's the Watergate scandal of 1972 for which I'm best remembered, a sobering legacy and a grave lesson in the importance of integrity for all leaders.’

Upon the presentation of the introduction, three hints, and the learning content to the user, the generated content undergoes a quality check and is provided with a score. The quality assessment is essential to ensure that the generated content is accurate and engages the user to provide effective learning. The content is evaluated based on several criteria, and the score reflects the overall quality of the generated content. The score determines the quality of the introduction, the learning content, helpfulness of the hints. For instance, the score provided to the above-mentioned hints are as follows:
‘introduction_quality: 8,
hint_1_helpfulness: 3,
hint_2_helpfulness: 6,
hint_3_helpfulness: 8,
learning_content_quality: 9.’

The score serves as a measure of how well the introduction captures the user's attention, provides an appropriate overview of the virtual character, and engages the user. The quality of the introduction is important, as it decides the user's interaction with the virtual character and the learning content.

The three hints are also evaluated for their effectiveness and helpfulness. Hints play a significant role in guiding the user toward the correct guess or deeper understanding without giving away the answer too easily. The AI engine 122 analyzes how helpful these hints are in progressively revealing information about the virtual character or subject matter. If the hints are well generated, then the user might not face difficulty in providing the correct answer.

Lastly, the learning content is evaluated for its educational value. The score indicates how well the content aligns with the user's learning objectives and educational standards, and how effectively it communicates the concepts. The content must be accurate and engaging to ensure the user gains a deeper understanding of the subject matter.

If the score is high, the content is effective and continues to be used in the learning session. If the score is low, the content may need to be revised or regenerated to meet the educational goals. This feedback loop ensures continuous improvement and refinement of the AI-generated content, ultimately enhancing the learning experience for the user. The AI engine 122 updates the learning content in real-time, if the quality check score is low.

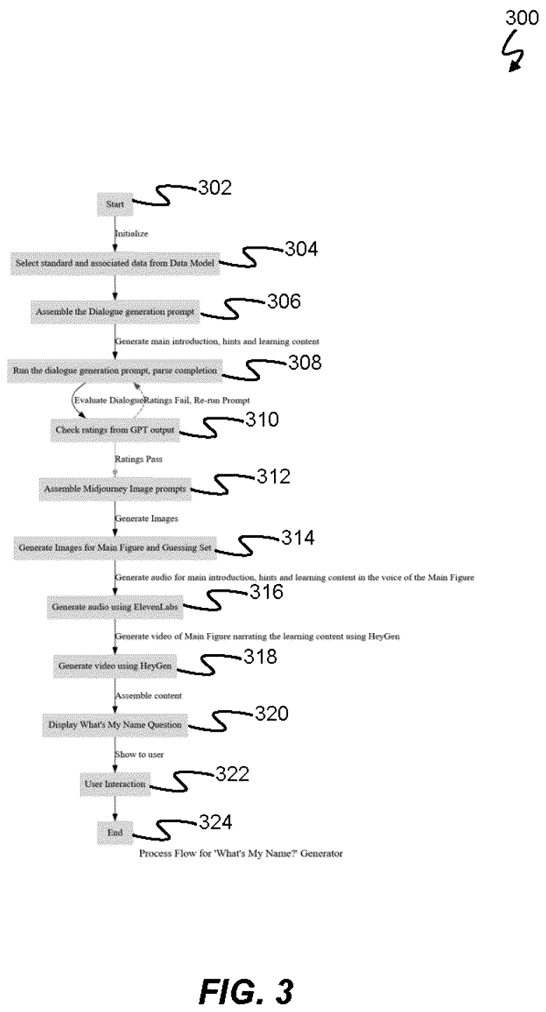

FIG. 3 depicts an exemplary virtual character identification game generation process 300, an embodiment of the virtual character identification process 200 of FIG. 2.

The virtual character identification game generation process 300 illustrates a game where the user has to identify the virtual character based on the audio-visual cues provided by the virtual character. As the user provides correct answers, the blurred image of the virtual character is gradually revealed. The gradual unveiling of the virtual character along with audio-visual cues enhances user engagement and interaction with the online learning platform 102.

The virtual character identification game generation process 300 begins when the user starts in operation 302 working on the online learning platform 102. The data collector 114 initiates the virtual character identification game generation process 300 by selecting a standard and its associated data in operation 304 from the user profile 108. Further, the details of the virtual character are extracted from the data model 110. The details, such as course ID, standard details, and virtual character details, including voice ID, and historical data of the virtual character, serve as the basic foundation for educational video generation.

Once the input data is collected and analyzed, the generated insights are provided to the prompt structure, generated by the prompt engineer. The prompt generator 120 uses the analyzed insights for populating the prompt structure. The populated prompts are then provided to the AI engine 122 to guide the AI engine to generate dialogues, audio files, images, and a cohesive educational video by combining them.

The AI engine 122 transfers the generated prompt to the dialogue generator 126 to generate the text-based dialogues for the virtual character in operation 306. The generated dialogues are tailored and relevant to the selected virtual character. The dialogue generator 126 uses the prompts to generate the dialogue including the introduction, three hints, and the learning material, which is used to educate the user. The introduction provides basic information about the virtual character and three hints provide audio-visual cues to the user to identify the virtual character. The prompt including the details of the dialogue generation is then run in operation 308 by the AI engine 122. The details are also followed with parsing to extract the relevant content from the prompts. The dialogue generator 126 used in the virtual character identification game generation process 300 to generate text dialogues is, in at least one embodiment, ChatGPT. However, those skilled in the art will appreciate that the dialogue generator 126 can utilize other similar tools including but not limited to Gemini and Claude. The user provides the generated prompts to the dialogue generator 126, generating the text dialogues for the virtual character. Once the dialogues are generated, the dialogues are parsed and evaluated for quality and relevance.

The generated dialogues are passed on for a quality check where the generated dialogues are provided with ratings in operation 310. The quality check ensures that the dialogue meets specific standards. If the ratings pass, the process moves to the next step. If the ratings fail, the prompt is rerun and reviewed to ensure the dialogue meets educational and engagement standards.

When the dialogues passes the rating check in operation 310, the prompts are provided 312 to the image generator 130 to generate the photorealistic images in operation 314 of the virtual character along with a guessing set of figures. The initial image generated by the image generator 130 is a blurred image that keeps on revealing progressively as the user interacts with the online learning platform 102 and provides correct responses. The image generator used in the virtual character identification game generation process 300 for generating photorealistic images of the virtual character is MidJourney, although not only limited to MidJourney, other tools like Dall-E can also be used.

Once the images are ready, the audio files are generated in operation 316 using the text-to-speech converter 128 which utilizes text-to-speech synthesis. The text dialogues generated by the dialogue generator 126 are converted to an audio file. The audio file is generated to match the voice with the voice of the virtual character. The text-to-speech converter 128 used in the virtual character identification game generation process 300 for generating an audio file of the virtual character is ElevenLabs. However, it should be noted that other tools like Azure text-to-speech, Amazon Polly, and other similar tools may also be used to generate the audio files.

Once the audio and images are available, the virtual character identification game generation process 300 proceeds to video generation in operation 318. The video generator 312 combines images and audio to create an educational video featuring the virtual character narrating the learning content to the user. This video serves as an engaging multimedia presentation for the user. The video generator 132 used in the virtual character identification game generation process 300 for generating an educational video of the virtual character is HeyGen, although other tools like VEED, Colossyan Creator, Rask AI, Murf.ai, and so on can also be used.

After the video is created, the final content is presented to the user in operation 320, including a blurred image of the virtual character, ten options for the user, and three hints in an audio-visual format. The presented content is interactive content to the user, allowing them to guess the identity of the virtual character. The user can interact in operation 322 with the online learning platform 102 to make guesses and receive feedback in real time. If the user makes the correct guess, the blurred image is revealed and if the user makes the incorrect guess, a different hint is provided to the user to make a guess again. The virtual character identification game generation process 300 ends when the user identifies the virtual character in operation 322.

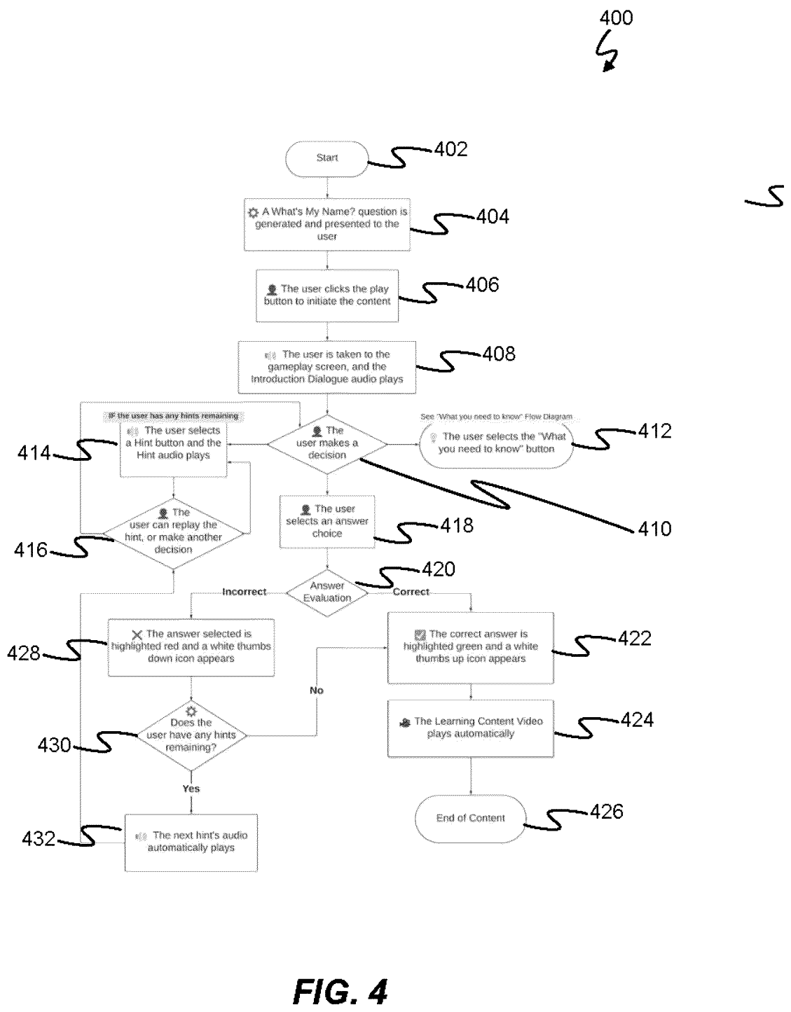

FIG. 4 depicts an exemplary user interaction process in operation 400 with the online learning platform 102, which is an embodiment of the virtual character identification process 200 of FIG. 2.

The user interaction process 400 begins when a user logs in to the online learning platform 102, and the virtual character identification game is initiated in operation 402. The game starts by generating and displaying a question titled ‘What's my name?’ on the user interface 104 of the online learning platform 102. In this question, the user is presented with a blurred image of the virtual character and must identify the character using the provided audio-visual cues in operation 404. To access the game, the user clicks on the play button in operation 406, which takes the user to the gameplay screen. Subsequently, an introduction message in operation 408 plays, providing a brief description of the virtual character.

At this point, in operation 410 the user can choose to either directly access the learning content by selecting ‘What you need to know,’ in operation 412 which provides immediate access to an educational video generated by the video generator 132, or opt to use hints. In this case, the user does not make any guesses for identifying the virtual character and directly looks out for the solution.

If the user chooses to use hints in operation 414, they can select from the available hints, which are provided in audio form. These hints are generated using the text-to-speech converter 128, converting text dialogues from the dialogue generator 126 into spoken audio. The user has the option to replay hints or make additional decisions, such as selecting other options or requesting further hints in operation 416.

The user then selects an answer from a list of ten figure names, with one option being correct in operation 418. The answer provided by the user is evaluated in operation 420 and highlights the correct response with a green indicator and a thumbs-up sign in operation 422. Consequently, the learning content, including an educational video featuring the virtual character, plays automatically. The blurred image of the character is also revealed as soon as the user provides the correct answer. This learning content is produced in operation 424 by the video generator 132, which combines dialogues, audio, and images from the dialogue generator 126, text-to-speech converter 128, and image generator 130 respectively. The game concludes at this point in operation 426.

If the user's response is incorrect, the answer is marked with a red indicator and a thumbs-down sign in operation 428. The user's response is checked whether any hints are remaining or not 430. If hints are available, the next hint audio plays when the user clicks on the corresponding active hint. If no hints are left, the learning content is displayed automatically, and the virtual character identification game ends 432.

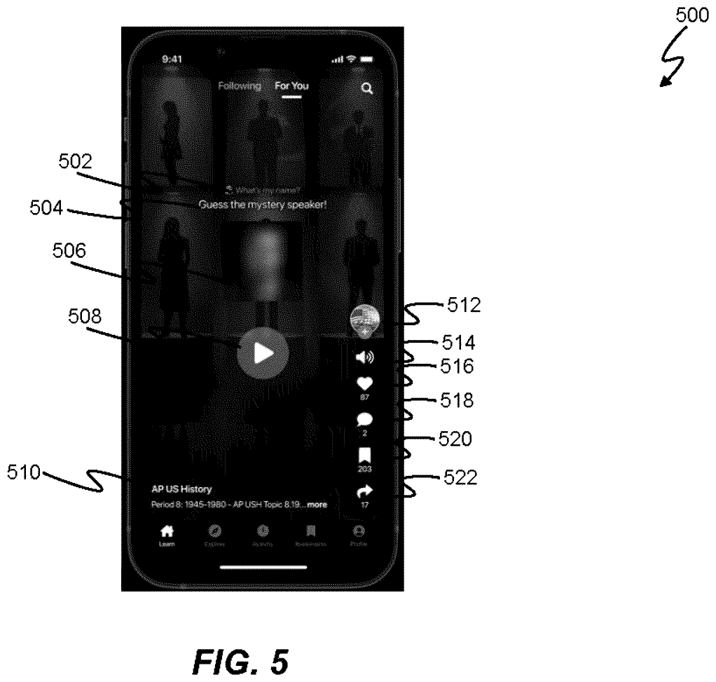

FIG. 5 depicts an exemplary user interface 500 presenting a virtual character identification game to the user.

The user interface 500 discloses the virtual character identification game ‘What's My Name?’ 502 to the user. In this game, the user has to identify the virtual character using audio-visual cues. The user is asked to ‘Guess The Mystery Speaker’ 504 based on the audio-visual cues provided to the user by the virtual character. The virtual character is presented to the user as a blurred image 506. The user can click on the play button 508 to start the virtual character identification game. Upon clicking on the play button 508, the virtual character shown in the form of the blurred image 506 presents an introduction, and audio-visual cues to the user to help them identify the virtual character correctly.

The details of the course and the educational standard 510 are also displayed on the user interface 500. For instance, in the case of the present example, the details of the course and the educational standard 510 include course ‘AP US History’ and details ‘Period 8:1945-1980: AP USH: Topic 8.19.’ The page in which the virtual character identification game is visible to the user is visible on the right side of the user interface 500, the user can click on tab 512 to follow the page. Also, the user can manage the sound by clicking on the tab 514.

Further, the user can like, comment, bookmark, and share the content by clicking on the tabs ‘Like’ 516, ‘Comment’ 518, ‘Bookmark’ 520, and “Share” 522. The content presented to the user is in a similar format to social media, where the user can scroll through and receive the content. The content here is the virtual character identification game.

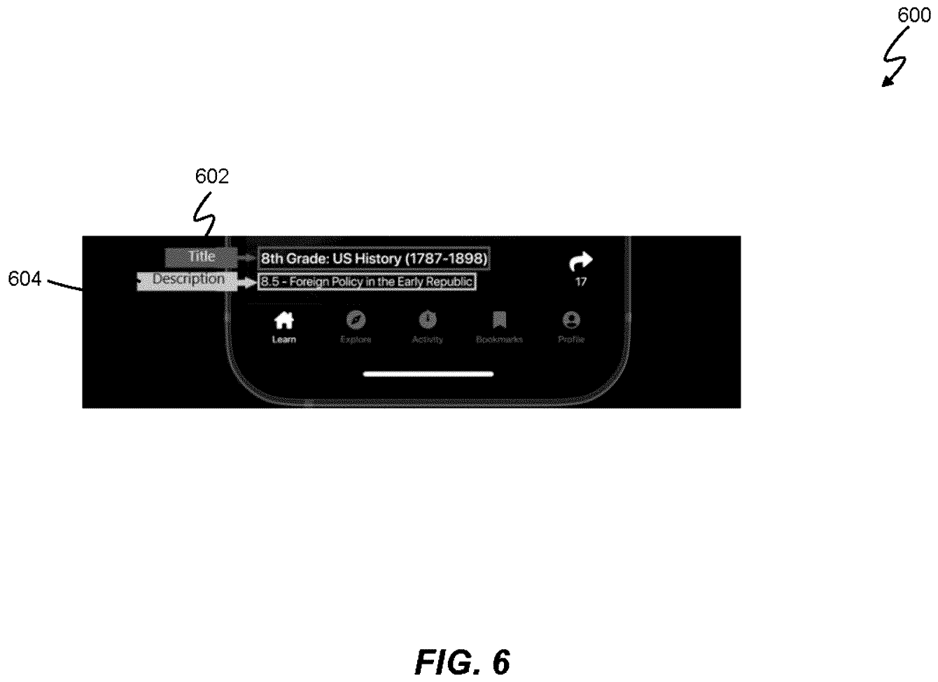

FIG. 6 depicts an exemplary user interface 600 that discloses the details of the user's educational standard and the subject matter they are currently studying.

The user interface 600 discloses the details of the educational standard and the course. The title 602 along with the description 604 of the educational standard and course is disclosed. The virtual character is chosen in correspondence with the educational standard of the user, which is fetched from the user profile 108, and stored in the memory 106 of the online learning platform 102. In the case of the present example, the title 602 is ‘8th Grade: US History (1787-1898), and the description 604 of the subject is given as ‘8.5-Foreign policy in the early republic’. This means that the user is in Grade 8 and is currently studying chapter 8.5. Further, the virtual character will be chosen in correspondence to the Grade 8 syllabus.

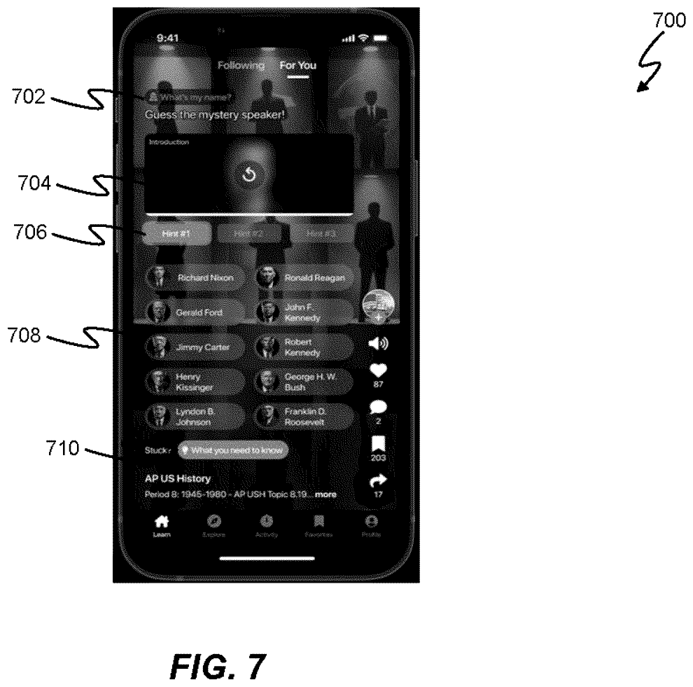

FIG. 7 depicts an exemplary user interface 700 presenting a virtual character identification game to the user along with a blurred image 704 of the virtual character, three hints 706, and ten guessing set figure's names 708.

Upon clicking on the play button 508 on the user interface 500, the user gets access to the virtual character identification game ‘What's My Name?’ 702, where the user has to identify the virtual character who is presented to the user in the form of blurred image 704. The virtual character provides audio-visual cues to the user in the form of an introductory message, and three hints 706 one by one. The user has to identify the virtual character based on that audio-visual cue, if the user provides a correct answer then the image of the virtual character is revealed progressively. On the contrary, if the user provides an incorrect response, then the user can make use of the hints 706 provided to them.

Further, the user can also click on the tab ‘What you need to know?’ 710 to directly know the answer to the virtual character identification game, without even attempting or guessing any option.

Initially, the user is provided with an introduction message from the virtual character, where the virtual character introduces himself/herself very briefly. Based on these introductory details the user can select the response from the list of ten guessing set figures name 708. The list of ten guessing set figures name 708 includes one correct name of the virtual character whose image is blurred. If the user selects the correct option from the list of ten guessing set figures name 708, the blurred image 704 of the virtual character is revealed progressively. However, if the user makes an incorrect guess, then the user can make use of the hints 706 provided to them.

After the guessing and identification game is done, the educational video is displayed to the user which is generated by the video generator 132. The educational video features the virtual character and provides the learning content to the user. The learning content is in correspondence with the virtual character and the current educational standard of the user.

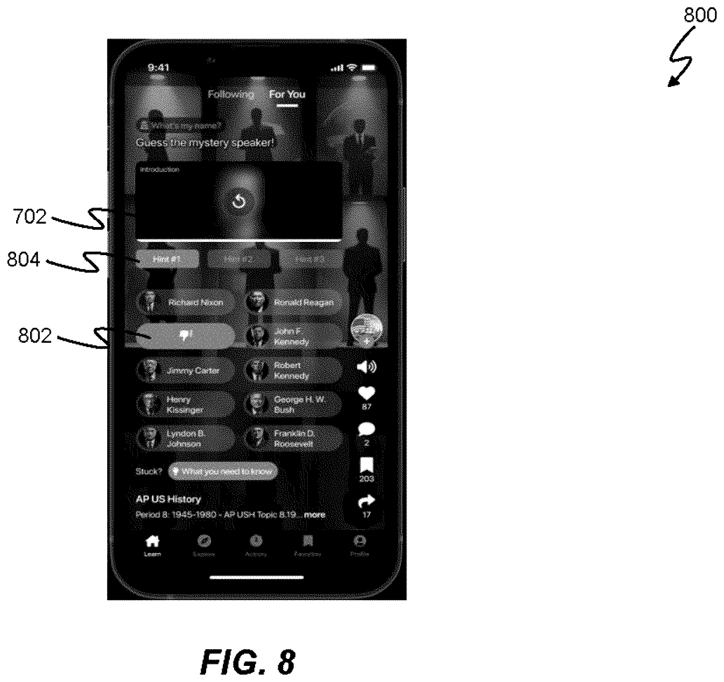

FIG. 8 depicts an exemplary user interface 800 displaying the incorrect response provided by the user which is denoted with red color.

Upon listening to the audio-visual introductory message by the virtual character in the user interface 700, the user can guess the speaker who is speaking the introductory message based on the voice and the details that the virtual character is sharing. For example, an introduction message may include ‘Oh, you're in luck! You have the opportunity to guess a forceful name in the American Revolution, though I hardly bore arms. Instead, my arsenal included a keen mind, a fierce will, and an extraordinary gift of persuasion. Have I grasped your attention? Can you guess who I am?’ The user has to identify the virtual character based on the details provided.

The user interface 800 shows that the user has given an incorrect response and due to this the selected option 802 has turned into red color. The user has selected option 802 from the list of ten guessing set figures name 708. Since the user has provided the incorrect response, the user gets access to the ‘Hint 1’ 804. As soon as the user clicks on the ‘Hint 1’ 804, the user is presented with another audio-visual cue that provides more detailed information about the virtual character. For instance, the details provided to the user in the ‘Hint 1’ 804 may include ‘Let's not discount my panache for cultivating, harvesting—not garden beds, mind you, but minds! My influence trickled down to the family hearth, imparting wisdom and sparking thoughts in many a young mind.’

The user can utilize this audio-visual cue to make a guess again, to identify the virtual character. If the user makes the correct guess, the blurred image 704 is revealed to the user. However, if the user does not provide the correct answer, the user is provided with another hint.

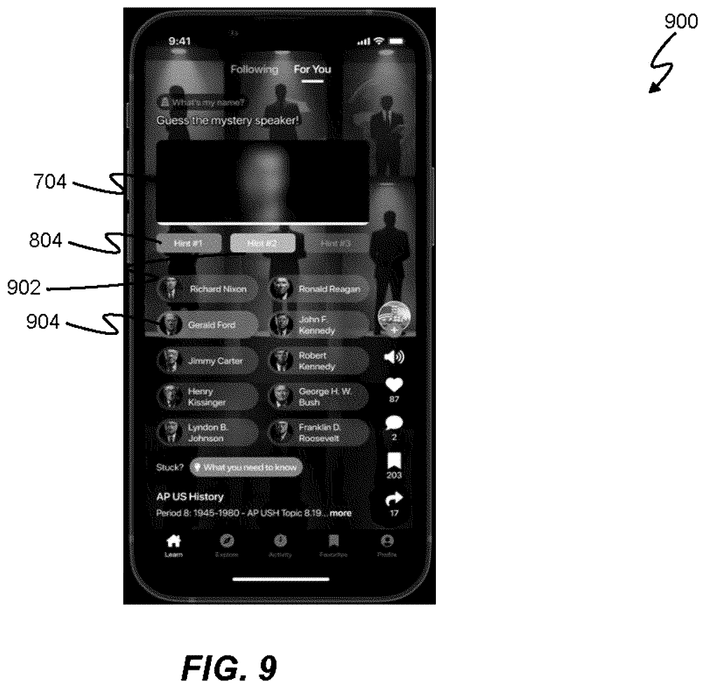

FIG. 9 depicts an exemplary user interface 900 displaying that the user is provided with another hint 902 when the user provides an incorrect response.

Upon listening to the ‘Hint 1’ 804 on the user interface 800, the user is allowed to again guess to identify the virtual character. Since the user has again made an incorrect response, shown with a red color 904, the user is given access to the ‘Hint 2’ 902. For instance, the details provided to the user in the ‘Hint 2’ 902 may include ‘Goodness! It looks like you're still in the dust. Here's something to consider: I was often the catalyst and a conduit for unseen revolutions, taking shape behind the moiré curtains of the domestic world.’

Similarly, if the user makes more incorrect answers, another hint is provided to the user. After that, the user is given no more hints, and the educational video generated using the video generator 132 is displayed to the user.

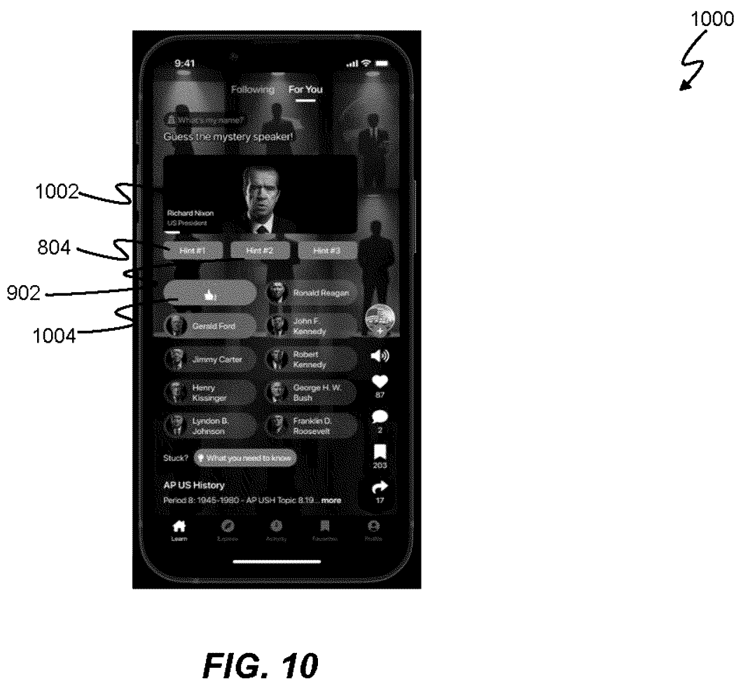

FIG. 10 depicts an exemplary user interface 1000 displaying the revealed image 1002 of the virtual character, and an educational video when the user submits the correct response.

After listening to multiple hints, the user provides the correct response, which is denoted by a green color 1004. As soon as the user provides the correct response, the blurred image 704 of the virtual character is revealed to the user. The revealed image 1002 is the image that appears when the user provides the correct answer 1004. The revealed image 1002 comes along with an educational video in the form of learning content, featuring the virtual character, in the audio-visual format.

For instance, the learning content may include ‘Well, it's high time to introduce myself. I am Abigail Adams, the wife of the second U.S. President, John Adams. My intellectual pursuits, wisdom, and advocacy for women's rights have made me an essential element in establishing the ideal of ‘republican motherhood’. My constant nudges to my husband to consider women's rights in the political scheme have etched my name in the annals of American history. ‘The learning content generated by the dialogue generator 126 is in correspondence with the educational standards of the user.

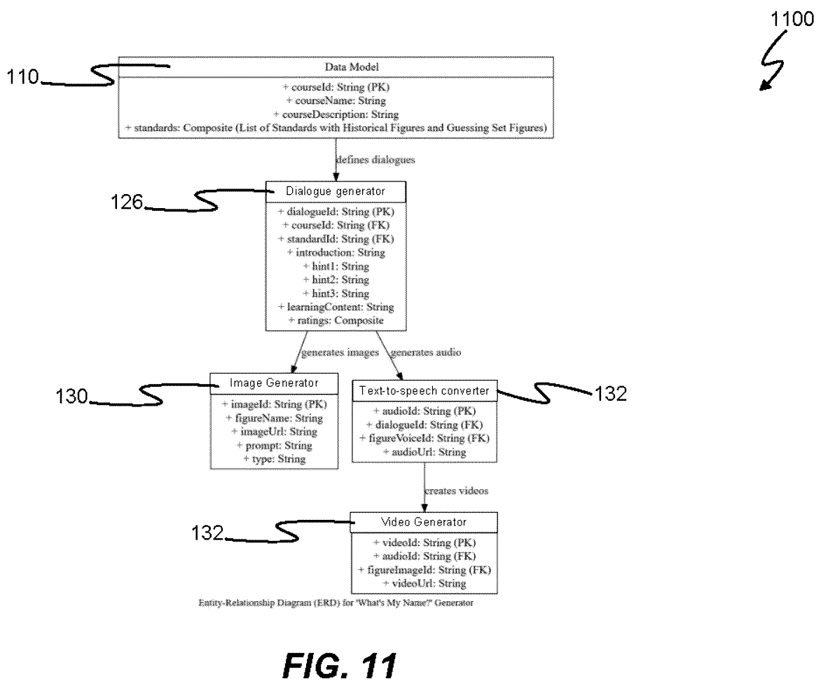

FIG. 11 depicts a data structure 1100 for organizing data to create an educational video featuring the virtual character presenting the learning content.

The data structure 1100 represents an entity relationship diagram (ERD), which is a visual representation of how entities, such as people, objects, components, or concepts, relate to each other in a database. The data structure 110 illustrates the AI-driven online learning platform 102, named ‘What's My Name?’ i.e., the user has to identify the virtual character by providing the correct response based on the hints provided by the AI engine 122. The online learning platform 102 combines dialogue, images, and audio to generate an educational video featuring a virtual character and providing audio-visual hints or cues to the user.

The data model 110 is the main component that holds essential course-related data, acting as the starting point for video generation. The data model 110 includes attributes like courseId, courseName, and courseDescription, which uniquely identify each course. Additionally, the data model 110 stores a list of standards, which include both historical figures and guessing set figure names. This list serves as a source of reference for generating dialogues and audio content related to the virtual character. The data model 110 ensures that each course is linked to the correct educational standards and virtual characters.

The dialogue generator 126 is responsible for creating educational dialogues that form the basis of the interaction with the virtual character. These dialogues generated are in text format. The dialogue generator 126 stores details such as dialogueId, courseId, and standardId to ensure that each dialogue generated is in correspondence with the course and standards of the user. The dialogues include an introduction, three hints, and specific learning content that help guide the user in identifying the virtual character. These dialogues are not only educational but also in correspondence to the course content, creating a personalized and engaging learning experience. The model also includes a rating criterion to assess the effectiveness of the dialogues provided to the user.

The text-to-speech converter 128 converts the generated text dialogues into realistic audio files. The text-to-speech converter 128 includes a dialogueId and a figure VoiceId to ensure the voice used corresponds to the correct virtual character. The audio files are generated using text-to-speech synthesis technology and are stored with their respective audioUrl. The text-to-speech converter 128 model ensures that users receive auditory feedback that is aligned with the text dialogue.

The image generator 130 created dynamic photorealistic images of the virtual character. The image generator 130 stores an imageId, figureName, imageUrl, and prompt, which are used to generate photorealistic images of the virtual character and the guessing set figures. The initial image presented to the user is a blurred image of the virtual character. The images enhance the user's experience by providing visual clues or hints, and reveal the blurred image to the user based on the correct response provided by the user, where initially blurred images become clearer as the user interacts with the online learning platform 102 and makes correct guesses. This real-time image manipulation is designed to increase user engagement and interaction within the online learning platform 102.

Finally, the video generator 132 combines the generated audio and images into an educational video featuring a virtual character, who provides cues to the user in audio-visual format. Using these cues, the user can identify the virtual character. The video generator 132 stores a videoId and links to the text-to-speech converter 128 and image generator 130. The video content is assembled using the generated audio and dynamic images, and the final product is stored as a videoUrl.

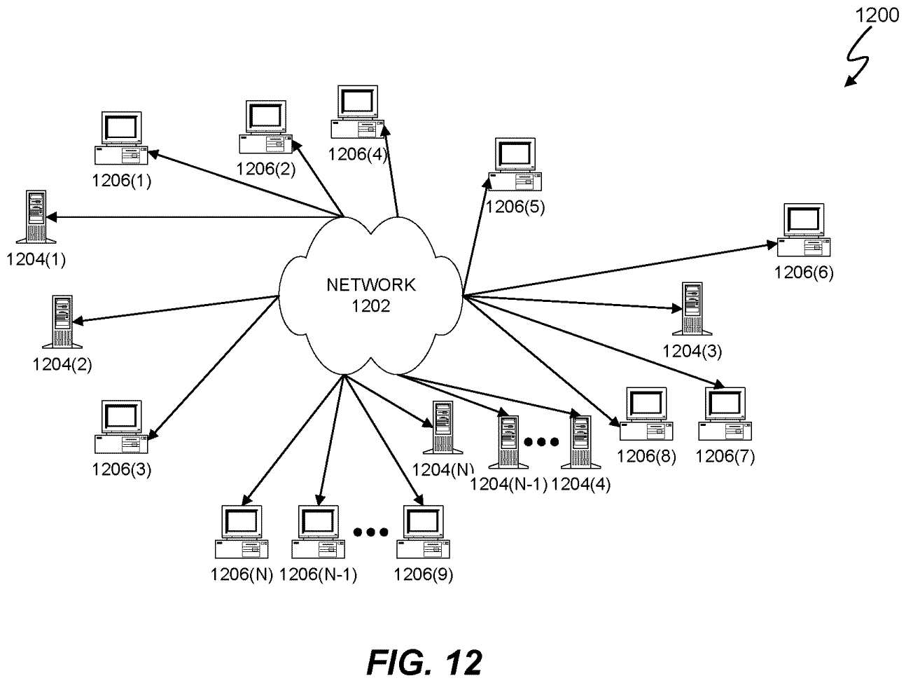

FIG. 12 is a block diagram illustrating a network environment in which a virtual character identification system 100 and process 200 based on generated dialogue and images, by the user using an online learning platform 102 may be practiced. Network 1202 (e.g. a private wide area network (WAN) or the Internet) includes several networked server computer systems 1204(1)-(N) that are accessible by client computer systems 1206(1)-(N), where N is the number of server computer systems connected to the network. Communication between client computer systems 1206(1)-(N) and server computer systems 1204(1)-(N) typically occurs over a network, such as a public switched telephone network over asynchronous digital subscriber line (ADSL) telephone lines or high-bandwidth trunks, for example, communications channels providing T1 or OC3 service. Client computer systems 1206(1)-(N) typically access server computer systems 1204(1)-(N) through a service provider, such as an internet service provider (“ISP”) by executing application-specific software, commonly referred to as a browser, on one of client computer systems 1206(1)-(N).

Client computer systems 1206(1)-(N) and server computer systems 1204(1)-(N) are specialized computers programmed to improve conventional computer systems to implement and utilize the virtual character identification system 100 and process 200 based on generated dialogue and images, by the user using an online learning platform 102. The type of computer system that can be specially programmed to implement and utilize the virtual character identification system 100 and process 200 based on generated dialogue and images, by the user using an online learning platform 102 includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the virtual character identification system 100 and process 200 based on generated dialogue and images, by the user using an online learning platform 102 can be implemented using code stored in a tangible, non-transient computer-readable medium and executed by one or more processors. In at least one embodiment, the virtual character identification system 100 and process 200 based on generated dialogue and images, by the user using an online learning platform 102 can be implemented completely in hardware using, for example, logic circuits and other circuits including field programmable gate arrays.

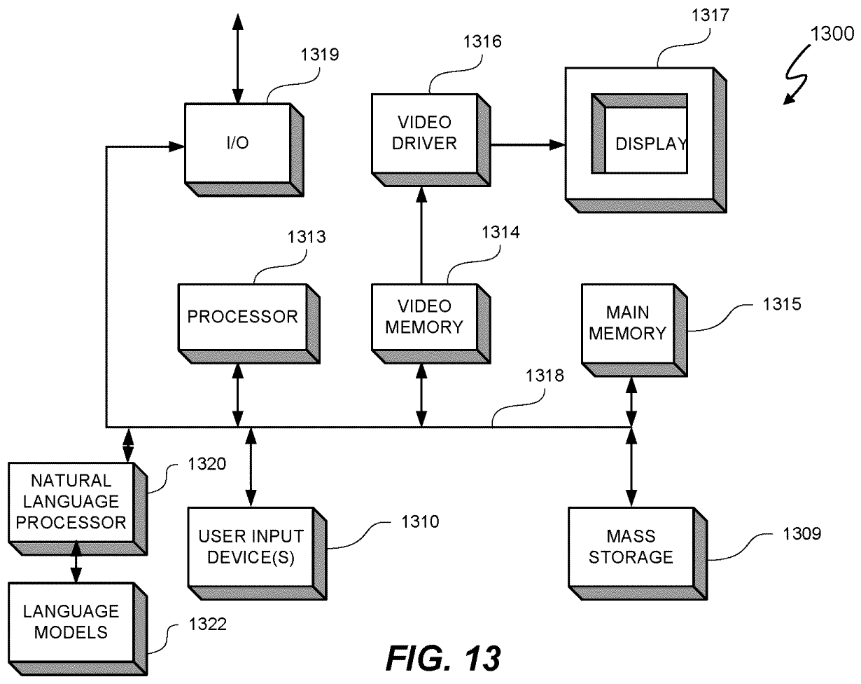

Embodiments of the virtual character identification system 100 and process 200 based on generated dialogue and images, by the user using an online learning platform 102 can be implemented on a computer system such as a special-purpose, special-programmed computer 1300 illustrated in FIG. 13. Input user device(s) 1310, such as a keyboard and/or mouse, are coupled to a bi-directional system bus 1318. The input user device(s) 1310 are for introducing user input to the computer system and communicating that user input to processor 1313. The computer system of FIG. 13 generally also includes a non-transitory video memory 1314, non-transitory main memory 1315, and non-transitory mass storage 1309, all coupled to bi-directional system bus 1318 along with input user device(s) 1310 and processor 1313. The mass storage 1309 may include fixed and removable media, such as a hard drive, one or more CDs or DVDs, solid state memory including flash memory, and other available mass storage technology. Bus 1318 may contain, for example, 32 of 64 address lines for addressing video memory 1314 or main memory 1315. The system bus 1318 also includes, for example, an n-bit data bus for transferring DATA between and among the components, such as CPU 1309, main memory 1315, video memory 1314, and mass storage 1309, where “n” is, for example, 32 or 64. Alternatively, multiplex data/address lines may be used instead of separate data and address lines.

I/O device(s) 1319 may provide connections to peripheral devices, such as a printer, and may also provide a direct connection to a remote server computer system via a telephone link or to the Internet via an ISP. I/O device(s) 1319 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1309, into main memory 1315 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1313, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1315 consists of dynamic random access memory (DRAM). Video memory 1314 is a dual-ported video random access memory. One port of the video memory 1314 is coupled to the video amplifier 1316. The video amplifier 1316 is used to drive the display 1317. Video amplifier 1316 is well-known in the art and may be implemented by any suitable means. This circuitry converts pixel DATA stored in video memory 1314 to a raster signal suitable for use by display 1317. Display 1317 is a type of monitor suitable for displaying graphic images.

The computer system described above is for purposes of example only. The virtual character identification system 100 and process 200 based on generated dialogue and images, by the user using an online learning platform 102 may be implemented in any type of computer system programming or processing environment. It is contemplated that the user guidance system 100 and process 200 using the real-time tutor might be run on a stand-alone computer system, such as the one described above. The virtual character identification system 100 and process 200 based on generated dialogue and images, by the user using an online learning platform 102 might also be run from a server computer systems system that can be accessed by a plurality of client computer systems interconnected over an intranet network. Finally, the virtual character identification system 100 and process 200 based on generated dialogue and images, by the user using an online learning platform 102 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of guiding an artificial intelligence (AI) engine to identify a virtual character based on generated dialogue and images of the virtual character, by a user using an online learning platform, the method comprises:
executing code using one or more processors of a computer system to cause the computer system to perform operations comprising:
collecting input data from user profiles and data models, wherein the input data includes course and standard ID, standard details, and virtual character details;
analyzing the collected input data to generate the insights that are used for prompt generation;
generating prompts by populating a prompt structure based on the analyzed insights;
transferring the generated prompts to the AI engine to guide the AI engine to:
generate dialogues in the text format for the virtual character by utilizing machine-learning techniques, wherein the dialogues include an introduction, three hints, and a learning content;
generate audio files by converting the generated text dialogue to speech using text-to-speech synthesis;
generate dynamic images featuring the virtual character, wherein the image of the virtual character is initially blurred and progressively revealed based on user interaction and correct guesses by utilizing real-time image manipulation techniques;
generating an interactive audio-visual feedback to the user based on the user's interaction with the online learning platform, wherein the generated audio-visual feedback includes an educational video featuring the virtual character presenting the learning content.

2. The method of claim 1 wherein the virtual character is a historical figure avatar generated by the AI engine, who acts as a real-time tutor for the user using the online learning platform.

3. The method of claim 1 wherein the input data course, standard ID, and standard details are collected from the user profile and the virtual characters details are collected from the data model.

4. The method of claim 1 wherein the virtual character details include the name, image, and voice ID of the virtual character presented to the user on the online learning platform.

5. The method of claim 1 wherein the virtual character details further includes a guessing set figures name, that includes a list of ten historical figures including the name of the virtual character presented to the user on the online learning platform.

6. The method of claim 1 wherein the dialogues are generated in correspondence with the user's progress, standards, user interaction with the online learning platform, and virtual character's historical metadata.

7. The method of claim 1 wherein the generated introduction, three hints, and the learning content are in correspondence to the virtual character presented to the user.

8. The method of claim 1 wherein the interactive audio-visual feedback further comprises:
blurring and revealing of images based on correct or incorrect responses;
audio cues or hints when the user gives the incorrect response to facilitate the learning of the user and enhance user engagement;
color changes after the user interacts with the guessing set figure name, wherein the red color indicates the incorrect response and a green color indicates the correct response.

9. The method of claim 1 wherein the audio files are generated using a voice synthesis technique that matches the voice of the corresponding virtual character, enhancing auditory engagement by providing personalized and realistic voiceovers.

10. The method of claim 1 wherein the incorrect response provided by the user triggers the next hint and the correct response provided by the user clears the blurred image of the virtual character and provides additional educational learning content.

11. The method of claim 1 wherein the generated educational video featuring the virtual character is generated by combining the images and audio files to provide a lifelike representation of the virtual character presenting the learning content.

12. The method of claim 1 wherein the generated dialogues, audio, and educational video are created in correspondence with the educational standards of the user, thereby ensuring that the learning content is in correspondence with the educational standard of the user.

13. A system to guide an artificial intelligence (AI) engine to identify a virtual character based on generated dialogue and images of the virtual character, by a user using an online learning platform comprises:
one or more processors;
one or more processors of a computer system; and
one or more memories, coupled to the one or more processors, that store code and execution of the code by the one or more processors causes the computer system to perform operations comprising:
collecting input data from user profiles and data models using a data collector, wherein the input data includes course and standard ID, standard details, and virtual character details;
analyzing the collected input data using an analyzer to generate the insights that are used for prompt generation;
generating prompts using a prompt generator by populating a prompt structure based on the analyzed insights;
transferring the generated prompts to the AI engine to guide the AI engine to:
generate dialogues in the text format for the virtual character using a dialogue generator that utilizes machine-learning techniques, wherein the dialogues include an introduction, three hints, and a learning content;
generate audio files by converting the generated text dialogue to speech using a text-to-speech converter which utilizes text-to-speech synthesis;
generate dynamic images featuring the virtual character using an image generator, wherein the image of the virtual character is initially blurred and progressively revealed based on user interaction and correct guesses by utilizing real-time image manipulation techniques;
generating an interactive audio-visual feedback to the user based on the user's interaction with the online learning platform using a video generator, wherein the generated audio-visual feedback includes an educational video featuring the virtual character presenting the learning content.

14. The system of claim 13 wherein the generated blurred image, corresponding set of hints, guessing set figure name, and audio-visual feedback, including the educational video, are displayed to the user on a user interface, integrated within the online learning platform.

15. The system of claim 13 wherein the user interface displays the virtual character's image, which is blurred initially, and progressively reveals the image in response to the user's correct response.

16. The system of claim 13 wherein the data model stores educational standards, virtual character names, voice IDs, and related metadata, and uses this data to generate personalized educational content for each user.

17. The system of claim 13 wherein the image generator is configured to generate the photorealistic images of the virtual character and utilizes real-time image manipulation techniques to control the level of blurring and revealing of the image based on the user's response.

18. The system of claim 13 further comprises:
a feedback module that provides the generated interactive audio-visual feedback to the user, wherein the audio-visual feedback includes audio cues or hints when the user gives an incorrect response to facilitate the learning of the user and enhance user engagement, and color changes after the user interacts with a guessing set figure name.
